(19) United States
(12) Patent Application Publication
(10) Pub. No.: US 2023/0263181 A1
(43) Pub. Date: Aug. 24, 2023

(54) FOOD PRODUCTS FROM ROOT VEGETABLES

(71) Applicant: McCain Foods Limited, Florenceville-Bristol (CA)

(72) Inventors: Nigel Kirtley, Glencoe, IL (US); Raymond J. Laudano, Apache Junction, AZ (US); Derek E. Spors, Boulder, CO (US); Lora Nicolette Spizzirri, Inverness, IL (US); Celia Jane Holt, Newmarket (GB); Christopher Simon Dale, Shinfield (GB)

(21) Appl. No.: 18/169,490

(22) Filed: Feb. 15, 2023

Related U.S. Application Data
(60) Provisional application No. 63/311,567, filed on Feb. 18, 2022.

(51) Int. Cl. A23C 20/02; A23L 19/12

(52) U.S. Cl. CPC A23C 20/02; A23L 19/13

(57) ABSTRACT

A hard cheese analogue may be produced from a root vegetable-derived product. This liquid potato product may be formed from raw potatoes, which are subsequently treated and subjected to a high shear processing step, which allows for the formation of a liquid potato product exhibiting non-Newtonian rheological properties. Subsequently, this liquid potato product may be solidified over time to form the hard cheese analogue. Unlike certain other dairy-free cheese analogues, the present cheese analogue may be sliced, cut, shredded, and melted.

### RELATED APPLICATIONS

This application claims the priority benefit under 35 U.S.C. § 119(e) of U.S. Provisional Patent Application Ser. No. 63/311,567 entitled “FOOD PRODUCTS FROM ROOT VEGETABLES,” filed Feb. 18, 2022, the entire disclosure of which is incorporated herein by reference.

### BACKGROUND

### 1. Field of the Invention

The present invention is generally related to potato-based dairy analogue products that may replace certain dairy-based products in the present market. More generally, the present application is generally related to the production of solid cheese analogues from liquid potato products.

### 2. Description of the Related Art

There has been an increasing emphasis on the production of healthy food products primarily derived from vegetables and other organic plant-based products. Such products may allow for the production of food analogues that can be used to replace certain food products that can cause allergic and/or gastrointestinal distress for a large portion of the consuming population. For instance, these food products derived from vegetables and other organic plant-based products could be used to produce dairy analogues, such as cheeses, which generally can not be consumed by those who are sensitive to dairy ingredients or wish to follow a specific dietary practice (e.g., vegans).

However, these existing food products may exhibit one or more deficiencies, such as poor taste, inadequate texture, allergy risks, high production costs, and overall unhealthy formulations. Thus, there still is a need to identify and efficiently produce a healthy food product, such as dairy analogues, from plant-based sources.

### SUMMARY

One or more embodiments generally concern a method for producing a dairy analogue. Generally, the method comprises: (a) providing an initial potato feed comprising a plurality of potatoes; (b) at least partially gelatinizing at least a portion of the initial potato feed to thereby form a gelatinized potato feed; (c) shearing at least a portion of the gelatinous potato feed at a temperature of at least 50° C. for at least 2 minutes to thereby form a liquid potato product; (d) introducing at least a portion of the liquid potato product into a shaped mold; and solidifying the liquid potato product in the shaped mold to thereby form the dairy analogue. Furthermore, the shearing occurs in the presence of one or more of the following: (i) at least one oil exhibiting a melting point in the range of 23° C. to 45° C., or (ii) at least one native starch and/or a modified starch. The dairy analogue is generally a cheese analogue.

One or more embodiments generally concern a method for producing a cheese analogue. Generally, the method comprises: (a) providing an initial potato feed comprising a plurality of potatoes; (b) at least partially gelatinizing at least a portion of the initial potato feed to thereby form a gelatinized potato feed; (c) preheating at least a portion of the gelatinized potato feed in the optional presence of one or more additives to thereby form a preheated potato feed at a temperature of at least 65° C.; (d) shearing at least a portion of the preheated potato feed for at least 2 minutes to thereby form a liquid potato product; introducing at least a portion of the liquid potato product into a shaped mold; and (f) solidifying the liquid potato product in the shaped mold for at least five days to thereby form the cheese analogue. Furthermore, the shearing occurs in the presence of one or more of the following: (i) at least one oil exhibiting a melting point in the range of 23° C. to 45° C., or (ii) at least one native starch and/or a modified starch, wherein the native starch and modified starch comprise an amylose content of less than 19 weight percent, based on the total weight of the starch.

One or more embodiments generally concern a method for producing a dairy analogue. Generally, the method comprises: (a) providing an initial potato feed comprising a plurality of potatoes; (b) at least partially gelatinizing at least a portion of the initial potato feed to thereby form a gelatinized potato feed; (c) shearing at least a portion of said gelatinized potato feed at a temperature of at least 25° C. to thereby form a liquid potato product, wherein said shearing provides at least 100 kJ/kg of mechanical work as measured over a time period of 30 minutes or less; (d) introducing at least a portion of the liquid potato product in a shaped mold; and (e) solidifying said liquid potato product in said shaped mold to thereby form said dairy analogue. Furthermore, the shearing occurs in the presence of one or more of the following: (i) at least one oil or (ii) at least one native starch and/or a modified starch. Moreover, the liquid potato product has a particle fineness of less than 125 microns as measured with a BYK-Gardner 2512 Metal Grind Gauge (PD-250) in accordance with ISO 1524 (2020). Additionally, the dairy analogue exhibits a maximum load of at least 100 grams as measured at 15 days after said solidifying as measured with a Brookfield CTX Texture Analyzer fitted with probe TA2/1000 at a constant rate (2 mm/sec). The dairy analogue is generally a cheese analogue.

One or more embodiments generally concern a dairy analogue, such as a cheese analogue, formed from a liquid potato product. Generally, the dairy analogue exhibits a maximum load of at least 100 grams as measured at 15 days after said solidifying as measured with a Brookfield CTX Texture Analyzer fitted with probe TA2/1000 at a constant rate (2 mm/sec). The liquid potato product: (a) comprises potatoes and water; (b) comprises one or more of the following—(i) at least one oil exhibiting a melting point in the range of 23° C. to 45° C., or (ii) at least one native starch and/or a modified starch, wherein said native starch and modified starch comprise an amylose content of less than 19 weight percent, based on the total weight of the starch; and (c) has a particle fineness of less than 125 microns as measured with a BYK-Gardner 2512 Metal.

### BRIEF DESCRIPTION OF THE FIGURES

Embodiments of the present invention are described herein with reference to the following drawing figures, wherein:

FIG. 1 depicts an exemplary Liquid P production system that may be employed to at least partially convert one or more potato-containing feeds into Liquid P and food products containing Liquid P;

FIG. 2 is a graph depicting the rheological profiles from Example 1 at Days 0-3 of a potato product produced using a conventional shearing process;

FIG. 3 is a graph depicting the rheological profiles from Example 1 at Days 0-3 of a Liquid P product produced using the inventive shearing process;

FIG. 4 is a graph depicting the shear stress relative to the shear rate of the Day 0 samples of Example 1 (inventive Liquid P and conventional shearing processes); and

FIG. 5 is a graph depicting the shear stress relative to the shear rate of the Day 3 samples of Example 1 (inventive Liquid P and conventional shearing processes);

FIG. 6 depicts a microscopy image (100× magnification) of the cold mill-coarse grind product of Example 2;

FIG. 7 depicts a microscopy image (100× magnification) of the cold mill-fine grind product of Example 3;

FIG. 8 depicts a microscopy image (100× magnification) of the hot mill-fine grind product of Example 4;

FIG. 9 depicts the texture measurements at Day 6 for Examples 2-4;

FIG. 10 depicts the texture measurements at Day 16 for Examples 2-4;

FIG. 11 depicts the texture measurements at Day 2 for Example 5 and Comparative Example 1;

FIG. 12 depicts the texture measurements at Day 4 for Example 5 and Comparative Example 1;

FIG. 13 depicts the texture measurements at Day 15 for Example 5 and Comparative Example 1;

FIG. 14 depicts the texture measurements at Day 26 for Example 5 and Comparative Example 1;

FIG. 15 depicts the texture measurements at Day 70 for Example 5 and Comparative Example 1;

FIG. 16 depicts the texture measurements at Day 2 for Examples 8-12;

FIG. 17 depicts the texture measurements at Day 2 for Comparative Examples 4-8;

FIG. 18 depicts the texture measurements at Day 15 for Examples 6-8;

FIG. 19 depicts the texture measurements at Day 15 for Comparative Examples 2-4; and

FIG. 20 depicts the texture measurements at Day 23 for Examples 13 and 14 and a conventional Colby Jack cheese.

### DETAILED DESCRIPTION

We have discovered that unique dairy analogues, such as a solid cheese analogue, may be produced using specific types of liquid potato products produced in accordance with the high shear process described herein. More particularly, we have discovered that a hard cheese analogue, which can be melted, shredded, ground, and/or sliced like a conventional hard cheese, can be formed from the liquid potato products described herein. As discussed below in greater detail, it has been observed that the process and system described herein can create a unique liquid potato product, i.e., Liquid P, which can be used to produce various types of dairy analogues that exhibit one or more desirable traits.

As used herein, the term “Liquid P” may be used interchangeably with “liquid potato product” and both refer to a substance containing at least 5 weight percent potato and having a dynamic viscosity in the range of 70 to 250,000 cP at a shear rate of 4¹/s and a temperature between 12.5° C. to 95° C.

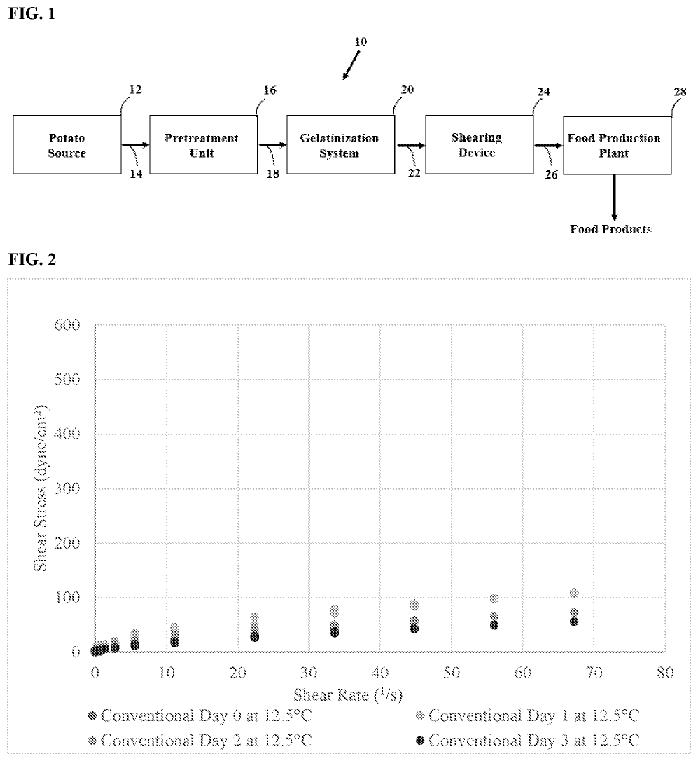

FIG. 1 depicts an exemplary Liquid P production system 10 that may be employed to at least partially convert one or more potato-containing feeds into Liquid P and food products containing Liquid P. It should be understood that the Liquid P production system shown in FIG. 1 is just one example of a system within which the present invention can be embodied. Thus, the present invention may find application in a wide variety of other systems where it is desirable to efficiently and effectively produce Liquid P. The exemplary system illustrated in FIG. 1 will now be described in greater detail.

As shown above in FIG. 1, the Liquid P Production System 10 may comprise a potato source 12 for supplying one or more types of potatoes to the system 10. The potato source 12 can be, for example, a hopper, storage bin, railcar, trailer, or any other device that may hold or store potatoes and other types of vegetables.

In various embodiments, the potato feed 14 derived from the potato source 12 can comprise, consist essentially of, or consist of potatoes. Generally, in various embodiments, the potatoes supplied by the potato source 12 can comprise of any variety of Solanum tuberosum. Exemplary potato varieties can include, for example, Shepody potatoes, Bintje potatoes, American Blue potatoes, Royal potatoes, Innate Potatoes, Maris Piper potatoes, Focus potatoes, Yukon Gold potatoes, Lady Balfour potatoes, Kennebec potatoes, Colette potatoes, Chieftain potatoes, Innovator potatoes, Russet Burbank potatoes, purple potatoes, Russet potatoes, Bamberg potatoes, or combinations thereof.

In various embodiments, the potatoes derived from the potato source 12 can comprise whole raw potatoes.

In various embodiments, the potato feed 14 can comprise at least 25, 50, 75, 80, 85, 90, 95, or 99 weight percent of one or more potatoes, based on the total weight of the feed stream. In certain embodiments, the initial potato feed 14 can be formed entirely from one or more potatoes, which may be raw potatoes. Additionally, or in the alternative, the potato feed 14 can comprise less than 99, 95, 90, 85, 80, 75, 70, 65, 60, 55, or 50 weight percent of one or more potatoes, based on the total weight of the stream. Although not wishing to be bound by theory, it has been observed that the amount of potato in the potato feed can affect the “firmness” of the resulting Liquid P and dairy analogue. For example, it has been observed that the higher the potato content of the potato feed 14, the higher the firmness of the resulting product.

In various embodiments, the potato feed 14 can comprise less than 20, 15, 10, 5, 4, 3, 2, 1, 0.5, or 0.1 weight percent of an added dry potato starch and/or a dry rice starch. Additionally, or in the alternative, the potato feed 14 can comprise at least 0.1, 0.5, or 1 weight percent of added dry potato starch and/or dry rice starch. More particularly, in certain embodiments, the potato feed 14 can comprise substantially no added potato starch and/or rice starch. As used herein, “potato starch” refers to the powdered starch previously extracted from potatoes, while “rice starch” refers to the powdered starch previously extracted from rice.

In certain embodiments, the potato source 12 may also supply one or more other root vegetables, such as parsnips, celery root, sweet potatoes, yams, onions, red beets, carrots, or combinations thereof. These additional root vegetables may be added to influence the taste and/or color of the resulting cheese analogue.

In various embodiments, the potato feed 14 can comprise at least 1, 5, 10, 15, 20, or 25 weight percent and/or less than 90, 85, 80, 75, 70, 65, 60, 55, 50, 45, 40, 35, or 30 weight percent of one or more root vegetables, based on the total weight of the potato feed. In certain embodiments, the potato feed 14 can comprise substantially no root vegetables.

In various embodiments, the potato feed 14 may also comprise additional components, such as one or more oils, one or more low amylose starches (e.g., Tapioca starch and/or modified starch), one or more gums (e.g., guar, xanthan, and/or Ticagel® by Ingredion), one or more preservatives (e.g., sodium benzoate), one or more salts (e.g., sodium chloride), one or more acids (e.g., lactic acid and/or citric acid), one or more emulsifiers (e.g., lecithin, monoglycerides, diglycerides, and/or EmulsiSMART®), one or more flavorants (e.g., nutritional yeast, seasonings, and/or spices), one or more protein additives (e.g., pea protein and/or potato protein), water, or a combination thereof. Any one of these additional components may be added initially to the potato feed 14 or downstream during the processing of the potato feed 14 (as discussed below). In one or more embodiments, the potato feed 14 can comprise at least 1, 2, 3, 4, 5, 10, 15, 20, 25, 30, 35, 40, or 45 weight percent of one or more of these additional components, either alone or in any combination, based on the total weight of the potato feed. Additionally, or in the alternative, the potato feed 14 can comprise less than 90, 85, 80, 75, 70, 65, 60, 55, 50, 45, 40, 35, 30, 25, 20, 15, 10, 5, or 1 weight percent of one or more of these additional components, either alone or in any combination, based on the total weight of the potato feed.

In various embodiments, the potato feed 14 may comprise one or more low amylose starches (e.g., Tapioca starch and/or modified starch). These starches may be added initially to the potato feed 14 or downstream during the processing of the potato feed 14 (as discussed below). In one or more embodiments, the potato feed 14 can comprise at least 1, 2, 3, 4, 5, 10, 15, 20, 25, 30, 35, 40, or 45 weight percent of one or more starches, based on the total weight of the potato feed. Additionally, or in the alternative, the potato feed 14 can comprise less than 90, 85, 80, 75, 70, 65, 60, 55, 50, 45, 40, 35, 30, 25, 20, 15, 10, 5, or 1 weight percent of one or more starches, based on the total weight of the potato feed. Although not wishing to be bound by theory, it has been discovered that the addition of certain modified starches to the potato feed can result in a dairy analogue with superior texture and melt properties.

In various embodiments, the potato feed 14 may comprise one or more fats (e.g., oils). These fats may be added initially to the potato feed 14 or downstream during the processing of the potato feed 14 (as discussed below). Exemplary fats can include, for example, sunflower oil, coconut oil, hydrogenated palm oil, cocoa butter, shea butter, or combinations thereof. Generally, in one or more embodiments, the oil added to the gelatinized potato feed 22 can have a melting point in the range of 23° C. to 45° C. In one or more embodiments, the potato feed 14 can comprise at least 1, 2, 3, 4, 5, 10, 15, 20, 25, 30, 35, 40, or 45 weight percent of one or more fats (e.g., oils), based on the total weight of the potato feed. Additionally, or in the alternative, the potato feed 14 can comprise less than 90, 85, 80, 75, 70, 65, 60, 55, 50, 45, 40, 35, 30, 25, 20, 15, 10, 5, or 1 weight percent of one or more fats (e.g., oils), based on the total weight of the potato feed. Although not wishing to be bound by theory, it is believed that the resulting texture of the dairy analogue can be modified by changing the fat composition added to the feed. It has been observed that the resulting cheese analogue can have a firm texture when a fat with a higher saturated fat fraction content is utilized.

Turning again to FIG. 1, the potato feed 14 from the potato source 12 can be sent to a pretreatment unit 16 for further processing before any subsequent cooking and conversion steps. While in the pretreatment unit 16, the potato feed 14 can go undergo one or more treatments including, for example, freezing, washing, peeling, mashing, water bath, chelating, microwave heating, radio frequency heating, magnetic heating, electric field pulse heating, cubing, dicing, or combinations thereof. In certain embodiments, the potato feed 14 can be washed, peeled, washed again to remove any peel residue, and then diced into defined slices. In one or more embodiments, the potatoes and other root vegetables present in the potato feed 14 can be diced to pieces having average widths of at least 0.1, 0.15, 0.2, or 0.25 inches and/or less than 0.75, 0.6, or 0.5 inches.

In one or more embodiments, all of the potatoes in the potato feed 14 may be peeled.

After leaving the pretreatment unit 16, the pretreated potato feed 18 is then introduced into a blanching and gelatinization system 20. While in the blanching and gelatinization system 20, the pretreated potato feed 18 can undergo any known process or technique for at least partially gelatinizing at least a portion of the potatoes in the potato feed. In various embodiments, the blanching and gelatinization system 20 can comprise any system or device capable of subjecting the pretreated potato feed 18 to a gelatinization process, such as a microwave, a hot water bath, autoclave, or any other device known in the art.

Generally, the gelatinization process can involve any heat treatment capable of at least partially gelatinizing the potatoes in the pretreated potato feed 18. Such techniques may include, for example, microwaving, boiling, scalding, blanching, or combinations thereof.

In one or more embodiments, the gelatinization process comprises blanching. Generally, in various embodiments, the blanching process can involve: (i) contacting the pretreated potato feed 18 with hot water and/or steam and (ii) subsequently contacting the cooked potato feed with an aqueous solution to thereby form the gelatinized feed 22. In certain embodiments, the aqueous solution can comprise one or more chelating agents and/or pH-modifying agents, such as citric acid, EDTA, a phosphate compound, or a combination thereof.

Although not wishing to be bound by theory, it is believed that the blanching step may help to mitigate undesirable enzymes in the potato feed, remove the peels from the potatoes (if still present), and modify the texture of the potatoes in the potato feed.

In one or more embodiments, the first step of the blanching process can comprise contacting the pretreated potato feed 18 with heated water over a time period of at least 1, 2, 3, 4, or 5 minutes and/or less than 30, 25, 20, 15, or 10 minutes. In such embodiments, this water heat treatment can occur at around atmospheric pressures and at a temperature of at least 50° C., 55° C., 60° C., 65° C., 70° C., 75° C., or 80° C. Additionally or alternatively, in various embodiments, the water heat treatment can occur at a temperature of less than 150° C., 125° C., 100° C., 95° C., 90° C., 85° C., 80° C., 75° C., 70° C., 65° C., 60° C., or 55° C.

In one or more embodiments, the first step of the blanching process can comprise contacting the pretreated potato feed 18 with pressurized steam over a time period of at least 1, 2, 3, 4, or 5 minutes and/or less than 30, 25, 20, 15, or 10 minutes. In such embodiments, this steam treatment can occur at a gauge pressure of at least 10, 25, 50, 75, 100, or 125 psig and/or less than 300, 250, 200, 175, or 160 psig and at temperature of at least 100° C., 125° C., or 150° C. and/or less than 300° C., 250° C., 200° C., or 185° C.

In one or more embodiments, the second step of the blanching process can occur at a temperature of at least 10° C., 15° C., 20° C., 25° C., 30° C., 35° C., 40° C., 45° C., 50° C., 55° C., 60° C., 65° C., 70° C., 75° C., or 80° C. and/or less than 150° C., 125° C., 100° C., 95° C., 90° C., 85° C., 80° C., 75° C., 70° C., 65° C., or 60° C. Additionally or alternatively, in various embodiments, the second step of the blanching process can occur over a time period of less than 10, 5, 4, 3, 2, or 1 minutes.

In one or more embodiments, the blanching process may be used to preheat the pretreated potato feed 18 prior to the downstream shearing step (described below). By pre-heating the pretreated potato feed 18 during the blanching step, the resulting gelatinized potato feed 22 can be maintained at a temperature that will facilitate the downstream high shear processing in the shearing device. In various embodiments, after blanching, the gelatinized potato feed 22 may have a temperature of at least 55° C., 60° C., 65° C., 70° C., 75° C., or 80° C. and/or less than 150° C., 125° C., 100° C., 95° C., or 90° C.

In certain embodiments, the gelatinization process will remove very little water and/or solids from the pretreated potato feed 18. Unlike certain prior art gelatinization techniques that partially dehydrate the potato feeds, the gelatinization techniques of the present disclosure may attempt to retain much of the water, moisture, and solids naturally present in the potatoes. For example, in various embodiments, the moisture content (by weight) of the gelatinized potato feed 22 is not more than 50, 45, 40, 35, 30, 25, 20, 15, 10, 9, 8, 7, 6, 5, 4, 3, 2, or 1 percent lower than the moisture content of the pretreated potato feed 18. Additionally, or in the alternative, the moisture content (by weight) of the gelatinized potato feed 22 may actually be higher than the pretreated potato feed 18 by at least 1, 5, 10, 15, or 20 percent.

Additionally, or in the alternative, in certain embodiments, the moisture content of the gelatinized potato feed 22 may be at least 50, 55, 60, 65, 70, 75, 80, 85, 90, 91, 92, 93, 94, 95, 96, or 97 percent of the moisture content of the pretreated potato feed 18.

Therefore, in various embodiments, the gelatinization process does not dehydrate the potato feed and does not utilize a dehydration treatment, such as drying or any other treatment which removes moisture from the potato feed and results in the treated potato feed having less moisture than the initial potato feed.

Furthermore, in various embodiments, the potato feed may also be chemically treated using chelating agents to eliminate the possibility of subsequent non-enzymic browning. However, for the production process described herein, it may not be necessary to chelate the potato feed.

Optionally, in various embodiments, at least a portion of the gelatinized potato feed 22 leaving the gelatinization system 20 may be subjected to freezing prior to downstream treatment. Such freezing steps can allow for the accumulation of gelatinized feedstocks for downstream processing. If such freezing steps are used, the gelatinized potato feed 22 may be thawed from freezing conditions before any additional downstream processing may occur.

In one or more embodiments, at least one or more additional components may be added to the gelatinized potato feed 22 prior to further downstream processing, such as the high shear processing step. For instance, one or more oils, one or more low amylose starches (e.g., Tapioca starch and/or modified starch), one or more gums (e.g., guar, xanthan, and/or Ticagel® by Ingredion), one or more preservatives (e.g., sodium benzoate), one or more salts (e.g., sodium chloride), one or more acids (e.g., lactic acid and/or citric acid), one or more emulsifiers (e.g., lecithin, monoglycerides, diglycerides, and/or EmulsiSMART®), one or more flavorants (e.g., nutritional yeast, seasonings, and/or spices), one or more protein additives (e.g., pea protein and/or potato protein), water, or a combination thereof, may be added to the gelatinized potato feed 22 at this stage. Exemplary oils can include, for example, sunflower oil, coconut oil, hydrogenated palm oil, cocoa butter, shea butter, or combinations thereof. Generally, in one or more embodiments, the oil added to the gelatinized potato feed 22 can have a melting point in the range of 23° C. to 45° C.

As noted above, in certain embodiments, the gelatinized potato feed 22 leaving the gelatinization system 20 may have a temperature of at least 55° C., 60° C., 65° C., 70° C., 75° C., or 80° C. and/or less than 150° C., 125° C., 100° C., 95° C., or 90° C. However, in additional or alternative embodiments, the gelatinized potato feed 22 may be subjected to additional or alternative pre-heating after leaving the gelatinization system 20 and the blanching step, particularly if the optional freezing step is utilized after the gelatinization system 20. In such embodiments, at least a portion of the gelatinized potato feed 22 may subjected to a preheating step prior to the downstream shearing step. For example, at least a portion of the gelatinized potato feed 22 may be subjected to boiling, heating in a water bath, heating in a microwave, and/or treatment in a Thermomix® processor (i.e., a food processor that heats and purees the feedstock). After these optional preheating steps, the gelatinized potato feed 22 may have a temperature of at least 55° C., 60° C., 65° C., 70° C., 75° C., 80° C., 85° C., or 90° C. and/or less than 150° C., 125° C., 110° C., or 100° C. In various embodiments, this preheating can occur in a vessel with a heated jacket and/or via direct steam injection using pressurized steam at a psi of at least 5, 10, 15, 20, 25, or 30 psi and/or less than 100, 90, 80, 70, 60, 50, or 40 psi.

Additionally, or alternatively, after leaving the gelatinization system 20, at least a portion of the gelatinized potato feed 22 may be subjected to a pre-milling step that involves pureeing at least a portion of the feed. This pureeing step can help further break up the particle size of the gelatinized potato feed 22 prior to the downstream high shearing step. The pureeing may be carried out in a food processor, such as a Thermomix® processor. During the pureeing step, at least a portion of the gelatinized potato feed 22 may be subjected to low shear pureeing in the food processor for at least 5 seconds, 10 seconds, 30 seconds, 1 minute, or 2 minutes and/or not more than 10 minutes, 5 minutes, or 3 minutes.

In certain embodiments where a food processor with a heating source (e.g., a heating jacket) is utilized, such as a Thermomix® processor or Stephan Cooker, the pureeing step and the pre-heating step may occur simultaneously. Thus, in such embodiments, the pre-milling step may occur at a temperature within any of the disclosed ranges for the preheating steps. Furthermore, in one or more embodiments, one or more of the aforementioned additives may be added during this pre-milling step. It has been discovered that milling the feed prior to or in combination with the preheating step can result in an improved texture within the final product (i.e., the dairy analogue) by making the product feel firmer. Although not wishing to be bound by theory, it is believed that the milling and preheating steps can cause the potato feed to be better milled and sheared during the subsequent shearing process, thereby yielding a Liquid P product with finer particulates, thereby resulting in a product with a “firmer” feel.

Upon leaving the gelatinization system 20, at least a portion of the gelatinized potato feed 22 can be introduced into a shearing device 24. While in the shearing device 24, the gelatinized potato feed 22 can be subjected to the specific temperature and shear conditions necessary to produce the Liquid P 26. Although not wishing to be bound by theory, the shearing step may be carried out at under specific temperature, pressure, and/or shear conditions so that the starch in the gelatinized potato feed 22 may become fully gelatinized, thereby facilitating the formation of the Liquid P. Generally, in various embodiments, the temperature of the gelatinized potato feed 22 must reach at least 67° C. in order to fully gelatinize the starch within the feed during the shearing step. This temperature can be derived from the shearing process and conditions and/or from an external heating source (e.g., a heating jacket around the shearing device and/or direct injection with pressurized steam as noted above). Thus, in various embodiments, the shearing step may be a form of hot milling due to these temperature requirements. As used herein, “shearing” refers to a mechanical treatment that induces a shear rate through the liquid which changes the underlying micro-structure. Thus, for example, shearing may include particle comminution.

In various embodiments, the gelatinized potato feed 22 has not been subjected to a dehydration treatment prior to being introduced into the shearing device 24. For example, prior to being introduced into the shearing device 24, the gelatinized potato feed 22 has not been subjected to a dehydration treatment that has previously removed moisture therefrom.

The shearing device 24 can comprise any shearing device known in the art capable of providing the high shear necessary to produce the Liquid P 26 from the gelatinized potato feed 22. Exemplary shearing devices can include, for example, a food processor, a high shear mixer with an impeller, or a high-speed turbine with a shroud. In certain embodiments, the shearing device 24 can comprise a high-speed turbine with a shroud, wherein the rpm of the turbine can influence the temperature and time conditions of the shearing process. In specific embodiments, the shearing device can comprise a Stephan-type batch cooker with a high-speed impeller and swept wall scraper, a Vitamix mixer, or a Robot Coupe food processor. In more specific embodiments, the shearing device can comprise a Robot Coupe food processor with at least two blades and at least 1 HP of power. In such embodiments, the shearing device can operate at an RPM of at least 2,500, 3,000, 3,100, 3,200, or 3,300. The shearing step may occur in multiple units that are different from each other. For example, it is possible to conduct the shearing in separate processing units, such as an off-line or in-line Urschel Comitrol, which are capable of generating extremely high shearing conditions.

In various embodiments, the shearing step can occur at a temperature of at least 25° C., 30° C., 35° C., 40° C., 45° C., 50° C., 55° C., 60° C., 65° C., or 70° C. and/or less than 150° C., 125° C., 110° C., 100° C., or 90° C. and over a time period of at least 1, 2, 3, 4, 5, 6, 7, 8, 9, or 10 minutes and/or less than 60, 55, 50, 45, 40, 35, 30, 25, 20, or 15 minutes. Generally, in more particular embodiments, the shearing step can occur at a temperature of at least 65° C. for 2 to 15 minutes. In an exemplary embodiment, the shearing step may occur at a temperature of at least 65° C. for 2 to 15 minutes in a Robot Couple food processor. As would be readily appreciated by one skilled in the art, the temperatures and time periods of the shearing step may be altered so as to be slightly outside of the recited ranges disclosed herein; however, such conditions would still fall under the scope of the present disclosure. This temperature can be derived from the shearing rates and conditions, pre-heating the gelatinized potato feed 22 prior to the shearing step, and/or from an external heating source (e.g., a heating jacket around the shearing device).

Additionally or alternatively, in various embodiments, the shearing can comprise one prolonged shearing step (e.g., maintaining a temperature of 80° C. for 8 minutes under constant shear) or can be broken up into a plurality of stages that may be distinguished by different temperatures, shear intensities, and duration. For instance, the high shearing step may be broken up into at least 2, 3, 4, or 5 different stages, with each stage comprising its own temperature, duration, and shear intensity. The temperature and time parameters for each shearing stage may be selected from the aforementioned temperature and time ranges for the shearing process.

Additionally or alternatively, in various embodiments, the shearing can occur at a pressure of at least 1, 5, 10, or 14 psig and/or less than 1,000, 900, 800, 700, 600, 500, 400, 300, 200, 100, 50, 25, 20, or 15 psig.

Additionally or alternatively, in various embodiments, the shearing step(s) can provide a set amount of total mechanical work over a period of time. In one or more embodiments, the shearing step(s) can provide at least 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 195, or 200 kJ/kg of mechanical work, as measured over a time period of 60 minutes or less, 45 minutes or less, 30 minutes or less, or 15 minutes or less. Additionally, or in the alternative, the shearing step(s) can provide less than 500, 450, 400, 350, 300, 250, 200, 175, 150, 125, 100, 95, 90, 85, 80, 75, 70, 65, 60, 55, 50, 45, 40, 35, 30, or 25 kJ/kg of mechanical work, as measured over a time period of 60 minutes or less, 45 minutes or less, 30 minutes or less, or 15 minutes or less. In certain embodiments, the shearing step(s) can provide in the range of 4 to 80 kJ/kg of mechanical work over a time of 60 minutes or less, or 30 minutes or less.

In one or more embodiments, the shearing step(s) can provide at least 50, 55, 60, 65, 70, 75, 80, 85, 90, 95, 100, 105, 110, 115, 120, 125, 130, 135, 140, 145, 150, 155, 160, 165, 170, 175, 180, 195, or 200 kJ/kg of mechanical work, as measured over a time period of at least 1, 2, 3, 4, 5, 6, 7, 8, 9, or 10 minutes and/or less than 60, 55, 50, 45, 40, 35, 30, 25, 20, or 15 minutes. Additionally, or in the alternative, the shearing step(s) can provide less than 500, 450, 400, 350, 300, 250, 200, 175, 150, 125, or 100 kJ/kg of mechanical work, as measured over a time period of at least 1, 2, 3, 4, 5, 6, 7, 8, 9, or 10 minutes and/or less than 60, 55, 50, 45, 40, 35, 30, 25, 20, or 15 minutes.

As used herein, the total mechanical work per kg may be calculated by the following formula: (kW×sec)/kg, wherein “kW” refers to the average shaft mechanical power of the shearing device multiplied by the shearing processing time in seconds (“sec”), which is then divided by the batch size in kilograms (“kg”). In the calculations, “kJ” is the equivalent to (kW×sec) from the above formula. Furthermore, the mechanical shaft power of the shearing device can be either measured directly or derived from the electrical motor of device based on: (i) the line voltage and (ii) the line amps drawn, and then correcting for conversion losses using the manufacturer's specified power factor values and IE efficiency values, as well as any other drive chain frictional losses from gears and belts.

Additionally or alternatively, in various embodiments, the shearing can occur with a designated power intensity over a set period of time. The power intensity refers to the peak power input into the product while it is in the shearing zone of the shearing device. Generally, this is indicative of the shearing forces being applied to the product. In one or more embodiments, the shearing step(s) may apply a power intensity to the product of at least 0.1, 0.5, 1, 2, 3, 4, or 5 kW and/or less than 200, 150, 100, 90, 80, 70, 60, or 50 kW over a time of less than 5, 4, 3, 2, 1, or 0.5 seconds. The power may be calculated based on the aforementioned mechanical shaft power of the shearing device. In certain embodiments, the shearing step(s) may apply a power intensity to the product in the range of 3 to 40 kW over a time of 1 second or less.

In various embodiments, one or more fats (e.g., oils), one or more low amylose starches (e.g., Tapioca starch and/or modified starch), one or more gums (e.g., guar, xanthan, and/or Ticagel® by Ingredion), one or more preservatives (e.g., sodium benzoate), one or more salts (e.g., sodium chloride), one or more acids (e.g., lactic acid and/or citric acid), one or more emulsifiers (e.g., lecithin, monoglycerides, diglycerides, and/or EmulsiSMART®), one or more flavorants (e.g., nutritional yeast, seasonings, and/or spices), one or more protein additives (e.g., pea protein and/or potato protein), and/or water may be added to the shearing device 24 along with the gelatinized potato feed 22. Additionally, or in the alternative, in certain embodiments, one or more oils, one or more low amylose starches (e.g., Tapioca starch and/or modified starch), one or more gums (e.g., guar, xanthan, and/or Ticagel® by Ingredion), one or more preservatives (e.g., sodium benzoate), one or more salts (e.g., sodium chloride), one or more acids (e.g., lactic acid and/or citric acid), one or more emulsifiers (e.g., lecithin, monoglycerides, diglycerides, and/or) EmulsiSMART®, one or more flavorants (e.g., nutritional yeast, seasonings, and/or spices), one or more protein additives (e.g., pea protein and/or potato protein), and/or water may be added directly into the gelatinized potato feed 22 prior to introducing the feed 22 into the shearing device 24.

If added directly to the shearing device 24, the aforementioned additive ingredients (i.e., the oils, starches, salts, acids, emulsifiers, gums, protein additives, and/or water) may be added to the shearing device 24 at the same time with the gelatinized potato feed 22 or may be added at different intervals during the shearing process. For example, one or more of the aforementioned additive ingredients may be added at the transition between one or more shearing stages. Thus, for instance, the shearing process may begin with only the gelatinized potato feed 22; however, after the first shearing stage, one or more of the aforementioned additive ingredients may be added prior to or during the start of the second shearing stage.

The oils and water can be useful in producing the desired viscosity of the Liquid P and may also enhance certain taste and textural properties of the resulting Liquid P. Exemplary oils can include, for example, sunflower oil, coconut oil, hydrogenated palm oil, cocoa butter, shea butter, or combinations thereof. Generally, in one or more embodiments, the oil added to the formulations described herein can have a melting point in the range of 23° C. to 45° C. and, therefore, would be in the form of liquid during shearing. Although not wishing to be bound by theory, it is believed that the selection of an oil exhibiting a melting point within this range can facilitate the downstream production of cheese analogues that can be melted, shredded, sliced, and cut. For example, it has been observed that these oils may help maintain the firm texture of the resulting cheese analogue and provide an improved mouthfeel.

In certain embodiments, an oil is added to the shearing step, but water is not added. In yet other embodiments, both water and oil are added to the shearing step, along with the gelatinized potato feed 22.

Optionally, after the shearing step, the sheared feed may be subjected to additional milling. For example, the sheared feed may be optionally passed once or multiple times through a milling machine, such as an Urschel Comitrol or a high-pressure homogenizer. This optional post-shearing milling step may occur at a temperature within any of the disclosed ranges for the preheating and/or shearing steps. Thus, in such embodiments, the optional post-shearing milling step may occur at a temperature within any of the disclosed ranges for the preheating and/or shearing steps.

In various embodiments, at least a portion of the sheared potato feed may be subjected to an optional heat treatment after the shearing treatment. For instance, at least a portion of sheared potato feed may be introduced into a cooking device, where it can be subjected to temperatures so as to increase the temperature of the potato feed to at least 55° C., 60° C., 65° C., 67° C., 70° C., 75° C., 80° C., or 75° C. to thereby form the Liquid P. In such embodiments, it may be desirable to heat the sheared potato feed to a temperature that will fully gelatinize the starch therein. In various embodiments, this optional post-shearing heat treatment occurs at a temperature of at least 55° C., 60° C., 65° C., 67° C., 70° C., 75° C., 80° C., or 75° C. and/or less than 300° C., 200° C., 150° C., 125° C., or 100° C. and at atmospheric pressure. This optional heat treatment may occur over a time period of at least 0.5, 1, 2, 3, 4, 5, 6, 7, 8, 9, or 10 minutes and/or less than 2 hours, 1 hour, 50 minutes, 40 minutes, or 30 minutes. This heat treatment may be carried out via indirect heat (e.g., a heat jacket on the cooking device) and/or direct heat (e.g., direct steam injection into the sheared potato feed).

The various characteristics and properties of the Liquid P are described below. It should be noted that, while all of the following characteristics and properties may be listed separately, it is envisioned that each of the following characteristics and/or properties of the Liquid P are not mutually exclusive and may be combined and present in any combination, unless the combination of such characteristics conflicts. Furthermore, it should be noted that all weight percentages associated with the Liquid P formulations are based on the total weight of the Liquid P formulation, unless otherwise noted.

Due to the unique shearing processes described herein, the resulting Liquid P may contain a grind gauge particle size range that is formulated and desirable for forming dairy analogues, particularly cheese analogues, with superior textures. In various embodiments, the Liquid P may comprise a particle fineness of less than 250, 240, 230, 220, 210, 200, 190, 185, 180, 175, 170, 165, 160, 155, 150, 145, 140, 135, 130, 125, 120, 115, 110, 105, 100, 95, 90, 85, 80, 75, 70, 65, 60, 55, 50, 45, 40, 35, 30, 25, 20, 15, or 10 microns, as measured with a BYK-Gardner 2512 Metal Grind Gauge (PD-250) in accordance with ISO 1524 (2020). Additionally, or in the alternative, the Liquid P may comprise a particle fineness of at least 1, 2, 3, 4, 5, 6, 7, 8, 9, or 10 microns, as measured with a BYK-Gardner 2512 Metal Grind Gauge (PD-250) in accordance with ISO 1524 (2020). For example, the Liquid P may comprise a particle fineness in the range of 1 to 250, 1 to 200, 1 to 150, 1 to 130, 1 to 125, 1 to 100, 1 to 80, 1 to 60, 1 to 50, 1 to 40, 1 to 30, 1 to 25, 1 to 20, or 1 to 15 microns, as measured with a BYK-Gardner 2512 Metal Grind Gauge (PD-250) in accordance with ISO 1524 (2020). It should be noted that ISO 1524 (2020) was conducted with the gauge plate at room temperature (20-25° C.) because if the gauge plate was too cold, then measurements were difficult with recipes containing higher melting point oils.

In various embodiments, the Liquid P comprises at least 5, 10, 11, 12, 13, 14, 15, 16, 17, 18, 19, 20, 25, 30, 35, or 40 weight percent and/or less than 99, 95, 90, 85, 80, 75, 70, 65, 60, 55, or 50 weight percent of potatoes, such as those originally added in the initial potato feed, based on the total weight of the Liquid P composition.

In various embodiments, the oil is added in sufficient quantities so that the Liquid P comprises at least 1, 2, 3, 4, 5, 6, 7, 8, 9, 10, 11, 12, 13, 14, or 15 weight percent of one or more oils, based on the total weight of the Liquid P composition. Additionally, or in the alternative, the oil is added in sufficient quantities so that the Liquid P comprises less than 75, 70, 65, 60, 55, 50, 45, 40, 35, 30, 25, 20, 15, or 10 weight percent of one or more oils, based on the total weight of the Liquid P composition. Generally, the oils may comprise coconut oil, sunflower oil, cocoa butter, shea butter, or a combination thereof.

In specific embodiments, the Liquid P comprises: (i) a sunflower oil and (ii) a coconut oil or cocoa butter. In such embodiments, the Liquid P may comprise in the range of 1 to 10, 2 to 8, or 3 to 7 weight percent of sunflower oil and 5 to 45, 7 to 40, or 9 to 35 weight percent of coconut oil or cocoa butter, based on the total weight of the Liquid P composition.

In various embodiments, one or more specific starches and/or gums may be added during the process in sufficient quantities so that the Liquid P comprises at least 1, 2, 3, 4, 5, 6, 7, 8, 9, 10, 11, 12, 13, 14, 15, 16, 17, 18, 19, or 20 weight percent of at least one low amylose starch, such as a Tapioca starch, a modified starch, or combination thereof, based on the total weight of the Liquid P composition. Additionally, or in the alternative, the Liquid P may comprise not more than 50, 45, 40, 35, 30, 25, 20, 19, 18, 17, 16, 15, 10, 5, or 1 weight percent of at least one low amylose starch, such as Tapioca starch, a modified starch, or combination thereof, based on the total weight of the Liquid P composition. As used herein, a “low amylose starch” refers to a starch that contains less than 19 weight percent of amylose, based on the total weight of the starch. Thus, a low amylose starch would typically not be a native potato starch, specific rice starches, or native corn starch. Generally, in one or more embodiments, the low amylose starch used herein comprises an amylose content of less than 19, 18.5, 18, 17.5, or 17 weight percent. Although not wishing to be bound by theory, it is believed that the use and incorporation of the right starch into the Liquid P formulation can enhance the resulting characteristics of the cheese analogues produced in accordance with the present disclosure. For example, it has been observed that the use of Tapioca starch and modified starches may facilitate the melting characteristics of the cheese analogues described herein.

In various embodiments, the one or more gums are added in sufficient quantities so that the Liquid P comprises at least 0.1, 0.5, 1, 2, 3, or 4 weight percent and/or less than 10, 9, 8, 7, 6, or 5 weight percent of the gums, based on the total weight of the Liquid P composition. Exemplary gums can include, for example, guar, xanthan, Ticagel® from Ingredion, or a combination thereof.

In various embodiments, the one or more gums are added in sufficient quantities so that the Liquid P comprises at least 0.1, 0.5, 1, 2, 3, or 4 weight percent and/or less than 10, 9, 8, 7, 6, or 5 weight percent of one or more protein additives (e.g., pea protein and/or potato protein), based on the total weight of the Liquid P composition.

In various embodiments, the water is added in sufficient quantities so that the Liquid P comprises at least 1, 2, 3, 4, 5, 6, 7, 8, 9, or 10 weight percent and/or less than 75, 70, 65, 60, 55, 50, 45, 40, 35, 30, 25, 20, or 15 weight percent of the water, based on the total weight of the Liquid P composition.

In various embodiments, the Liquid P can optionally include up to 50 weight percent of one or more additional complex carbohydrates, such as root vegetables, other than potatoes. In certain embodiments, the optional complex carbohydrates can have a higher fiber content than the potatoes used to make the Liquid P. Examples of additional complex carbohydrates suitable for use in Liquid P may include root vegetables, such as parsnips, celery root, sweet potatoes, onions, red beets, carrots, or combinations thereof. For example, in various embodiments, the Liquid P comprises at least 1, 2, or 5 weight percent and/or less than 60, 55, 50, 45, 40, 35, 30, 25, 20, 15, or 10 weight percent of one or more root vegetables, based on the total weight of the Liquid P composition.

In various embodiments, one or more preservatives (e.g., sodium benzoate) is added in sufficient quantities so that the Liquid P comprises at least 0.001, 0.005, 0.01, or 0.02 and/or less than 1, 0.5, 0.4, 0.3, 0.2, or 0.1 weight percent of one or more preservatives, based on the total weight of the Liquid P composition.

In various embodiments, optional flavorants, optional additives, and other optional vegetables and fruits may be added into the shearing device 24 along with the gelatinized potato feed 22. These flavorants can include, for example, spices, meat, cheese, herbs, other flavorants desired in the final food product, or combinations thereof. Exemplary additives that may be added may include, for example, protein supplements (e.g., chickpeas, soy, or combinations thereof), dietary fiber supplements, vitamins, minerals, or combinations thereof. The other vegetables and fruits that may be added at this stage can include, for example, Capsicum peppers (including sweet peppers and hot peppers), onions, spinach, kale, mushrooms, mango, artichokes, legumes, corn, olives, tomatoes, or combinations thereof. In various embodiments, the flavorants, additives, and other vegetables and fruits are added in sufficient quantities so that the Liquid P comprises at least 1, 2, 3, 4, 5, 6, 7, 8, 9, 10, 15, or 20 weight percent and/or less than 75, 70, 65, 60, 55, 50, 45, 40, 35, 30, 25, 15, 10, or 5 weight percent of flavorants, additives, other vegetables, and/or other fruits, based on the total weight of the Liquid P composition. Alternatively, in certain embodiments, the Liquid P may not contain any added water and/or flavorants.

Due to the unique shearing process and additives, the Liquid P 26 can be in the form of a viscous, flowable liquid that has a shiny and smooth appearance.

In various embodiments, the resulting Liquid P 26 can exhibit a viscosity at 12.5° C. or 25° C. of at least 100, 250, 500, 1,000, 1,500, 2,000, 2,500, 3,000, 3,500, 4,000, 4,500, or 5,000 cP and/or less than 250,000, 200,000, 150,000, 100,000, 90,000, 80,000, 70,000, 60,000, 50,000, 40,000, 30,000, 25,000, or 20,000 cP.

Although not wishing to be bound by theory, it is believed that the high shearing conditions used in the production of the Liquid P helps form its unique rheological profile. Generally, the Liquid P is a non-Newtonian fluid having a non-linear relationship between shear stress and shear rate. The Liquid P may exhibit its non-Newtonian characteristics by maintaining its non-linear relationship between shear stress and shear rate after prolonged storage for 24 hours, 48 hours, and 72 hours.

In various embodiments, the Liquid P may exhibit a shear stress at 12.5° C. of at least 5, 10, 15, 20, 25, 30, 35, 40, 45, 50, 75, 100, 125, 150, 175, 200, 225, 250, 275, 300, 325, 350, 375, 400, 425, or 450 dynes/cm² at a shear rate of 0, 5, 10, 15, or 20 Vs. Additionally or alternatively, in various embodiments, the Liquid P may exhibit a shear stress at 12.5° C. of less than 900, 800, 700, 600, 500, 450, 400, 350, 300, 250, 200, 150, 125, 100, 75, or 50 dynes/cm² at a shear rate of 0, 5, 10, 15, or 20 Vs. It should be noted that these above rheological measurements may be applicable to the Liquid P immediately after its production or after it has been stored for 24 hours (“Day 1”), 48 hours (“Day 2”), or 72 hours (“Day 3”) at 6° C. As noted above, due to the high shearing process utilized herein, the Liquid P may exhibit and maintain its non-Newtonian profile after storage for 24 hours (“Day 1”), 48 hours (“Day 2”), or 72 hours (“Day 3”) at 6° C.

In various embodiments, the Liquid P may exhibit one of the following shear stress profiles at 12.5° C. after storing the Liquid P for 24 hours (“Day 1”), 48 hours (“Day 2”), or 72 hours (“Day 3”) at 6° C.:

i. a shear stress of at least 15, 20, 25, 30, 35, 40, 45, 50, 75, 100, 125, or 150 dynes/cm² at a shear rate of 5 Vs, a shear stress of at least 25, 30, 35, 40, 45, 50, 75, 100, 125, or 150 dynes/cm² at a shear rate of 10 Vs, a shear stress of at least 35, 40, 45, 50, 75, 100, 125, or 150 dynes/cm² at a shear rate of 15 Vs, and/or a shear stress of at least 40, 45, 50, 75, 100, 125, 150, 175, 200, 225, 250, 275, 300, 325, 350, 375, or 400 dynes/cm² at a shear rate of 20 Vs, when the Liquid P comprises no complex carbohydrate materials, such as other root vegetables, or less than 10, 8, 6, 4, 2, or 1 weight percent of complex carbohydrate materials, such as other root vegetables.

As noted above, the Liquid P may be a non-Newtonian fluid and, therefore, exhibit a non-linear rheological profile. As used herein, “Y₁,” “Y₅,” “Y₁₀,” “Y₁₅,” “Y₂₀,” “Y₃₀,” and “Y₄₀” refer to the shear stress values (dynes/cm²) of Liquid P at 12.5° C. at shear rates of 1, 5, 10, 15, 20, 30, and 40¹/s, respectively. Furthermore, as used herein, “Y₁₋₅,” “Y₅₋₁₀,” “Y₁₀₋₁₅,” “Y₁₅₋₂₀,” “Y₁₋₁₀,” “Y₁₀₋₂₀,” “Y₂₀₋₃₀,” and Y₃₀₋₄₀” refer to the change in shear stress values between Y₁ and Y₅, Y₅ and Y₁₀, Y₁₀ and Y₁₅, Y₁₅ and Y₂₀, Y₁ and Y₁₀, Y₁₀ and Y₂₀, Y₂₀ and Y₃₀, and Y₃₀ and Y₄₀, respectively.

In various embodiments, the Liquid P may exhibit at least 1, 2, 3, 4, 5, or 6 of the following rheological properties:
i. Y₁₋₅≠Y₅₋₁₀≠Y₁₀₋₁₅≠Y₁₅₋₂₀;
ii. Y₁₀ is at least 50, 100, 150, 200, 250, or 300 percent greater than Y₁₀₋₁₅ and/or Y₁₅₋₂₀;
iii. Y₁₋₅ is at least 50, 100, 150, 200, 250, or 300 percent greater than Y₅₋₁₀, Y₁₀₋₁₅, and/or Y₁₅₋₂₀;
iv. Y₅₋₁₀ is at least 50, 100, 150, 200, 250, or 300 percent greater than Y₁₀₋₁₅ and/or Y₁₅₋₂₀;
V. Y₁₋₅ is greater than Y₁₀₋₂₀, Y₂₀₋₃₀, and/or Y₃₀₋₄₀; and/or
vi. Y₁₋₁₀ is at least 25, 50, 75, 100, 125, or 150 percent greater than Y₁₀₋₂₀, Y₂₀₋₃₀, and/or Y₃₀₋₄₀.

It should be noted that these above rheological measurements may be applicable to the Liquid P immediately after it has been produced or after it has been stored for 24 hours (“Day 1”), 48 hours (“Day 2”), or 72 hours (“Day 3”) at 6° C. Furthermore, the above rheological properties may be measured at 12.5° C. When rheological property measurements and more than one storage criteria are claimed herein (e.g., “said rheological properties are either measured after storing said liquid potato product for 24 hours at 6° C., 48 hours at 6° C., or 72 hours at 6° C.”), infringement of the claimed rheological properties may be met if an infringing product exhibits the recited rheological property at any one of the recited storage criteria (e.g., after storing for 24 hours at 6° C.). In other words, in order to determine infringement of the aforementioned hypothetical claim, rheological tests need to be conducted at each of the recited storage criteria (e.g., after storing for 24 hours at 6° C., after storing for 48 hours at 6° C., and after storing for 72 hours at 6° C.).

Due to the high shearing process described herein, the Liquid P formulation may exhibit a unique particle portfolio derived directly from the shearing process. Under microscopic examination using an OMAX M834SLPLAN-C50U3 compound microscope in Bright-field mode, samples of the Liquid P stained with Lugol solution may be characterized by fewer and smaller starch particles, as well as the presence of a continuous non-particulate starch matrix. In contrast, a low-sheared conventional potato product comprises numerous visible starch particles in the size range of 100 to 600 μm and no continuous non-particulate starch matrix.

As shown in FIG. 1, at least a portion of the Liquid P 26 can be transferred to a food production plant 28, where the Liquid P 26 can be used to produce various food products. As noted above, the Liquid P can be used to form a dairy analogue, such as a cheese analogue. As used herein, a “cheese analogue” refers to a food product that can be used in the same capacity as a cheese product, but does not contain any ingredients that are derived from milk.

Generally, in various embodiments, the Liquid P may be directly introduced (i.e., without any intervening steps) into the food production plant and formed into the desired dairy analogues right after the Liquid P is produced or after the Liquid P has been subjected to storage for 24, 48, or 96 hours at 0° C. to 7° C., generally around 6° C. More particularly, after producing the Liquid P as described above, the Liquid P may be directly used to form the desired food products without any intervening treatment steps (e.g., dehydration and/or rehydration) therebetween. In certain embodiments, the Liquid P may not be subjected to dehydration and rehydration prior to forming the desired dairy analogue, such as a cheese analogue.

In various embodiments, the dairy analogues, such as the cheese analogues, may comprise at least 1, 5, 10, 15, 20, 25, 30, 35, 40, 45, 50, 55, 60, 65, 70, 75, 80, 85, 90, 95, or 99 weight percent of the Liquid P, based on the total weight of the dairy analogue. Additionally or alternatively, in various embodiments, the dairy analogues, such as the cheese analogues, may comprise less than 99, 95, 90, 85, 80, or 75 weight percent of the Liquid P, based on the total weight of the dairy analogue. In certain embodiments, the dairy analogues, such as the cheese analogues, may be formed entirely from the Liquid P.

In one or more embodiments, a hard and solid cheese analogue may be produced from the Liquid P. Such cheese analogues may comprise at least 1, 5, 10, 15, 20, 25, 30, 35, 40, 45, 50, 55, 60, 65, 70, 75, 80, 85, 90, 95, or 99 weight percent of the Liquid P, based on the total weight of the cheese analogue. More particularly, in various embodiments, the cheese analogues may be formed entirely from the Liquid P.

Prior to forming the dairy analogue, additional flavorants, additives, vegetables, and/or fruits may be added to the Liquid P, so as to enhance and modify the flavor and texture of the resulting dairy analogue. These flavorants can include, for example, spices, meat, cheese, herbs, or combinations thereof. Exemplary additives that may be added may include, for example, protein supplements (e.g., chickpeas, soy, or combinations thereof), dietary fiber supplements, vitamins, minerals, or combinations thereof. The other vegetables and fruits that may be added at this stage can include, for example, Capsicum peppers (including sweet peppers and hot peppers), onions, spinach, kale, mushrooms, mango, artichokes, legumes, corn, olives, tomatoes, or combinations thereof. In various embodiments, the flavorants, additives, and other vegetables and fruits are added in sufficient quantities so that the dairy analogue comprises at least 1, 2, 3, 4, 5, 6, 7, 8, 9, 10, 15, or 20 weight percent and/or less than 75, 70, 65, 60, 55, 50, 45, 40, 35, 30, 25, 15, 10, or 5 weight percent of flavorants, additives, other vegetables, and/or other fruits, based on the total weight of the dairy analogue. It should be noted that these weight percentages do not include the amount of Liquid P in the dairy analogue and these additional ingredients are considered separately from the Liquid P when added after the formation of the Liquid P.

The cheese analogue may be formed by allowing the Liquid P to develop and solidify for an extended of time in a mold. More specifically, the process for forming the cheese analogue may comprise:
(a) filling a shaped mold (e.g., any geometric shape you want the final product to be in) with the Liquid P and any other optional additives; and
(b) storing the Liquid P and other optional additives in the mold for an extended period of time so as to cause the gel in the Liquid P to develop and solidify the resulting product.
   It should be noted that the “shaped mold” can include a temporary mold for forming the cheese analogue and from which the cheese analogue is removed therefrom before final packaging. Alternatively, the “shaped mold” can be the final commercial packaging that the cheese analogue will be packaged and sold commercially in. In various embodiments, the Liquid P must be stored in the mold at a temperature of at least 1° C., 2° C., 3° C., 4° C., 5° C., or 6° C. and/or less than 20° C., 18° C., 16° C., 15° C., 14° C., 13° C., 12° C., 11° C., 10° C., 9° C., 8° C., or 7° C. for at least 1 day (24 hours), 2 days (48 hours), 3 days (72 hours), 4 days (96 hours), 5 days (120 hours), 6 days (144 hours), or 7 days (168 hours) in order to form the cheese analogue. Generally, in one or more embodiments, the Liquid P must be stored in the mold at 1° C. to 20° C., 2° C. to 20° C., 3° C. to 20° C., 1° C. to 15° C., 1° C. to 10° C., 2° C. to 10° C., 1° C. to 9° C., 2° C. to 9° C., 2° C. to 10° C., 3° C. to 10° C., or 4° C. to 10° C., typically at 6° C., for at least 1 day (24 hours), 2 days (48 hours), 3 days (72 hours), 4 days (96 hours), 5 days (120 hours), 6 days (144 hours), or 7 days (168 hours) in order to form the cheese analogue. In certain embodiments, the cheese analogues are formed after storing the Liquid P in the mold at 4 to 6° C. for at least 7 days (168 hours). During this time, the starch in the Liquid P may at least partially develop and help form a solidified texture.

During the storage and solidification stage, in various embodiments, the Liquid P may be subjected to a cooling rate of at least 0.1, 0.2, 0.3, 0.4, 0.5, 0.6, 0.7, 0.8, 0.9, 1.0, 1.1, or 1.2 watts and/or less than 150, 125, 100, 90, 80, 70, 60, 50, 40, 30, 20, 15, 10, or 5 watts, as measured over periods of 1 hour, 12 hours, or 24 hours.

The mold used to form the cheese analogue can be configured into any desired geometric shape and with any desired thickness. This can offer an advantage over conventional cheese, as the shapes and thicknesses of the cheese analogue may be easy to configure as desired.

The Liquid P may be poured into the molds directly after the shearing step described herein. Alternatively, the Liquid P may be used to form the cheese analogue after storage for 24, 48, or 96 hours at 6° C.

The resulting cheese analogue may exhibit a solid texture and can be cut, shredded, ground, and/or sliced in the same manner as a traditional hard cheese, such as a cheddar cheese or parmesan cheese. The cheese analogue may exhibit a cohesive texture in the mouth and may readily break down and disperse when chewed. Due to its solid texture, the cheese analogue is not typically spreadable. Furthermore, in certain embodiments, the cheese analogue may be melted when heated.

The dairy analogues, such as the cheese analogues, may exhibit a superior texture due to the unique microstructure of the sheared potato derived from the shearing techniques described herein. In various embodiments, the dairy analogues, such as the cheese analogues, may exhibit a maximum load of at least 35, 40, 45, 50, 55, 60, 65, 70, 75, 80, 85, 90, 95, 100, 105, 110, 120, 130, 140, 150, 160, 170, 180, 190, 200, 205, 210, 215, 220, 225, 230, 235, 240, 250, 260, 270, 280, 290, 300, 325, 350, 375, 400, 425, 450, 475, 500, 525, 550, 575, 600, 625, 650, 675, 700, 725, or 750 grams, as measured at 1, 2, 3, 4, 5, 6, 7, 8, 9, 10, 15, 20, 25, 26, 30, 35, 40, 45, 50, 55, 60, 65, or 70 days after production and subsequent storage at 1 to 10° C., 2 to 8° C., 3 to 7° C., or 4 to 6° C. Additionally, or in the alternative, the dairy analogues, such as the cheese analogues, may exhibit a maximum load of less than 900, 850, 800, 750, 700, 650, 600, 550, 500, 450, 400, 350, 300, 250, 225, 200, 175, 150, 140, 130, 120, 110, or 100 grams, as measured at 1, 2, 3, 4, 5, 6, 7, 8, 9, 10, 15, 20, 25, 26, 30, 35, 40, 45, 50, 55, 60, 65, or 70 days after production and subsequent storage at 1 to 10° C., 2 to 8° C., 3 to 7° C., or 4 to 6° C.

The texture measurements are carried out with a Brookfield CTX Texture Analyzer fitted with a CTX050 load cell and a TA2/1000 probe. The samples may be removed from a refrigerator, where the sample is stored at about 4° C., and then allowed to warm up to 5-10° C. for testing. The data measurements are analyzed using the Texture Pro 1.0.14 software. The registered load corresponds to the mass applied to the sample in order to push the probe into the product at a constant rate (2 mm/sec) until the probe has traveled a predetermined distance of 10 mm, after which the probe is withdrawn at a constant rate (2 mm/sec).

Prior to and/or after forming the cheese analogue, at least a portion of the Liquid P forming the cheese analogue and/or at least a portion of the formed cheese analogue itself may be subjected to additional processing to further enhance the safety and/or characteristics of the resulting cheese analogue. For instance, at least a portion of the Liquid P (prior to forming the dairy analogue) and/or at least a portion of the dairy analogue (e.g., the cheese analogue) may be subjected to pasteurization/sterilization via any technology known in the art. Additionally, or in the alternative, at least a portion of the Liquid P (prior to forming the dairy analogue) and/or at least a portion of the dairy analogue (e.g., the cheese analogue) may be subjected to irradiation and/or electromagnetic radiation in order to deter any undesired microbial growth in the resulting dairy analogue. In yet other embodiments, at least a portion of the Liquid P (prior to forming the dairy analogue) and/or at least a portion of the dairy analogue (e.g., the cheese analogue) may be subjected to vibrative treatments and/or ultrasonic treatments in order to remove any entrapped air and/or change the product microstructure. In even yet other embodiments, at least a portion of the Liquid P (prior to forming the dairy analogue) and/or at least a portion of the dairy analogue (e.g., the cheese analogue) may be subjected to aeration in order to add desired air bubbles into the final dairy analogue for texture purposes.

In various embodiments, the formed cheese analogue may be subjected to stretching so as to enhance and manipulate the texture of the resulting cheese analogue.

In various embodiments, the cheese analogue may be further processed in a Natec FreePack or a traditional Hot Pack wrapping machine in the same manner as processed cheese so as to form individually-wrapped slices of cheese analogue product.

The resulting cheese analogue may be consumed directly (e.g., as a snacking cheese). Alternatively, the cheese analogue may be used in the same capacity that any hard cheese, such cheddar cheese or parmesan cheese, is typically used for. For example, the cheese analogue may be used as a topping for hamburgers, pizza, salads, or any other food item that generally uses sliced cheese. Additionally, in certain embodiments, the cheese analogue may be used to replace the cheese component in macaroni and cheese.

This invention can be further illustrated by the following examples of embodiments thereof, although it will be understood that these examples are included merely for the purposes of illustration and are not intended to limit the scope of the invention unless otherwise specifically indicated.

### EXAMPLES

### Example 1

The inventive Liquid P production method was tested and compared to a conventional process for producing potato-based food products (“Comparative Example A”). Both procedures used the same formulation, which is outlined in TABLE 1, below.

TABLE 1

| Ingredient | Weight Percent |
|---|---|
| Innovator Potatoes | 25 |
| (Diced) | |
| Sunflower Oil | 10 |
| Water | 65 |

The starting potato material was diced into ⅜ inch cubes. Furthermore, the potato cubes had been previously blanched, pregelatinized, treated with citric acid, and frozen. The potatoes were then gently thawed in a microwave (1200 W 110 v Panasonic Rotary model NSD997S). Afterwards, the diced and thawed potatoes were then mixed with the oil and water fractions and poured into a Vitamix mixer (Vitamix 5200 model VM0103 11.5 amp 110 v with variable speed). It was at this point that the conventional method and the inventive method described herein began to differ.

For the conventional method (Comparative Example A), the Vitamix was ran at a low speed setting (3-4 on dial) for 2 to 3 minutes until a consistent, homogeneous puree was achieved. The shear treatment was gentle enough to ensure that there was no appreciable temperature increase. The product was then heated in the microwave with stirring to achieve a temperature of 165 to 170° F. (74 to 77° C.).

For the inventive (i.e., Liquid P) method, the Vitamix was run at a high speed setting (10 on dial) for 5 to 10 minutes until there was a characteristic appearance change where the product became glossy with a distinct sheen and the power draw for the motor noticeably rose. With the amount of mechanical work being applied to the product there was a temperature increase to around 170 to 180° F. (77 to 82° C.) by the end of the shear treatment.

For both methods, the finished product was allowed to stand for 30 minutes at room temperature and a portion was then transferred to the rheometer sample chamber (Brookfield DV3TRVTJ with small sample adaptor kit using a SC4-28 spindle and TC-650 AP controller water bath), where it was placed in the temperature-controlled water bath (set at 12.5° C.). Subsequently, the rheometer spindle was positioned in the product. This represented the “Day 0” product. The remaining product was held in a refrigerator (4 to 8° C.) and samples were removed for measurement in the rheometer after 24, 48, and 72 hours, which referred to the “Day 1,” “Day 2,” and “Day 3” samples, respectively.

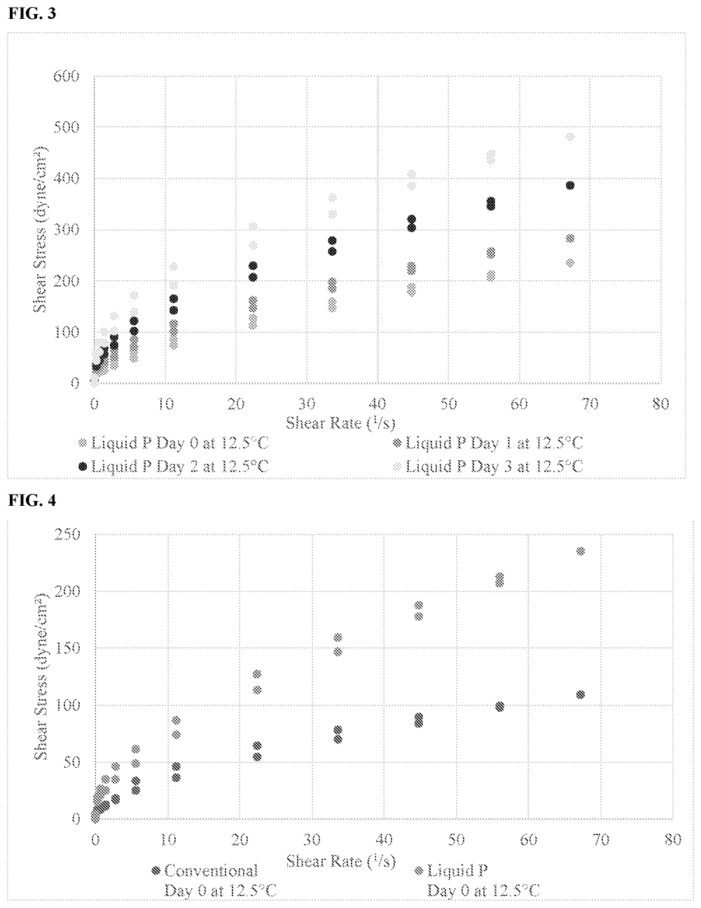

Once the sample had reached a temperature of 12.5° C., the rheometer ran through a prescribed program. During this program, the spindle was spun at a defined rpm which, together with the wall-to-wall distance between the spindle and the chamber, created a defined shear rate in the sample. Consequently, the corresponding torque can be measured, which directly translated to the experienced shear stress (dynes/cm). The program stepped through a series of rotational speeds at 30 second intervals to create a shear rate range covering 0 to 67.2¹/s. Once the maximum shear rate of 67.2¹/s was reached, the program reduced the rotational speed of the spindle in 30 second intervals back down to zero (as shown in TABLES 2-4 below). Thus, this resulted in two sets of data—one “up” and one “down.” The resulting shear stress values were then plotted against shear rate for both sets of data (i.e., the samples from the conventional method and the inventive method). TABLES 2 and 3, below, provide the “up” and one “down” shear stress values at Days 0, 1, 2, and 3 of the samples produced from the conventional process and the inventive Liquid P process described herein. FIGS. 2 and 3 depict the rheological profiles of the conventional samples and the Liquid P, respectively, at Days 0 to 3.

TABLE 2

| | Shear Rate | Conventional | Conventional | Conventional | Conventional |
|---|---|---|---|---|---|
| Step | (¹/s) | Day 0 at 12.5° C. | Day 1 at 12.5° C. | Day 2 at 12.5° C. | Day 3 at 12.5° C. |
| 1 | 0 | 0 | 0 | 0 | 0 |
| 2 | 0 | 2.8 | 4.2 | 1.4 | 1.4 |
| 3 | 0.28 | 7 | 11.2 | 2.8 | 1.4 |
| 4 | 0.7 | 9.8 | 12.6 | 7 | 4.2 |
| 5 | 1.4 | 11.2 | 14 | 8.4 | 5.6 |
| 6 | 2.8 | 18.2 | 19.6 | 15.4 | 8.4 |
| 7 | 5.6 | 33.6 | 32.2 | 21 | 14 |
| 8 | 11.2 | 46.2 | 46.2 | 30.8 | 19.6 |
| 9 | 22.4 | 64.4 | 64.4 | 42 | 29.4 |
| 10 | 33.6 | 78.4 | 78.4 | 50.4 | 37.8 |
| 11 | 44.8 | 89.6 | 89.6 | 58.8 | 43.4 |
| 12 | 56 | 99.4 | 99.4 | 65.8 | 49 |
| 13 | 67.2 | 109.2 | 107.8 | 72.8 | 56 |
| 14 | 0 | 0 | 0 | 0 | 0 |
| 15 | 56 | 98 | 98 | 65.8 | 50.4 |
| 16 | 44.8 | 84 | 84 | 56 | 42 |
| 17 | 33.6 | 70 | 70 | 46.2 | 35 |
| 18 | 22.4 | 54.6 | 54.6 | 35 | 26.6 |
| 19 | 11.2 | 36.4 | 37.8 | 23.8 | 16.8 |
| 20 | 5.6 | 25.2 | 26.6 | 15.4 | 11.2 |
| 21 | 2.8 | 16.8 | 19.6 | 11.2 | 7 |
| 22 | 1.4 | 12.6 | 14 | 8.4 | 5.6 |
| 23 | 0.7 | 8.4 | 12.6 | 5.6 | 1.4 |
| 24 | 0.28 | 8.4 | 8.4 | 5.6 | 2.8 |

TABLE 3

| | Shear Rate | Liquid P | Liquid P | Liquid P | Liquid P |
|---|---|---|---|---|---|
| Step | (¹/s) | Day 0 at 12.5° C. | Day 1 at 12.5° C. | Day 2 at 12.5° C. | Day 3 at 12.5° C. |
| 1 | 0 | 0 | 0 | 0 | 0 |
| 2 | 0 | 4.2 | 8.4 | 5.6 | 11.2 |
| 3 | 0.28 | 19.6 | 30.8 | 37.8 | 57.4 |
| 4 | 0.7 | 26.6 | 40.6 | 51.8 | 79.8 |
| 5 | 1.4 | 35 | 49 | 68.6 | 100.8 |
| 6 | 2.8 | 46.2 | 64.4 | 91 | 131.6 |
| 7 | 5.6 | 61.6 | 85.4 | 121.8 | 172.2 |
| 8 | 11.2 | 86.8 | 116.2 | 165.2 | 228.2 |
| 9 | 22.4 | 127.4 | 162.4 | 229.6 | 306.6 |
| 10 | 33.6 | 159.6 | 198.8 | 278.6 | 362.6 |
| 11 | 44.8 | 187.6 | 229.6 | 320.6 | 408.8 |
| 12 | 56 | 212.8 | 257.6 | 355.6 | 448 |
| 13 | 67.2 | 235.2 | 282.8 | 386.4 | 481.6 |
| 14 | 0 | 0 | 0 | 0 | 0 |
| 15 | 56 | 207.2 | 252 | 345.8 | 435.4 |
| 16 | 44.8 | 177.8 | 219.8 | 303.8 | 385 |
| 17 | 33.6 | 147 | 184.8 | 257.6 | 330.4 |
| 18 | 22.4 | 113.4 | 147 | 207.2 | 268.8 |
| 19 | 11.2 | 74.2 | 100.8 | 142.8 | 191.8 |
| 20 | 5.6 | 49 | 71.4 | 102.2 | 138.6 |
| 21 | 2.8 | 35 | 51.8 | 74.2 | 102.2 |
| 22 | 1.4 | 25.2 | 42 | 57.4 | 78.4 |
| 23 | 0.7 | 21 | 32.2 | 44.8 | 61.6 |
| 24 | 0.28 | 15.4 | 26.6 | 33.6 | 44.8 |

TABLE 4 also provides a direct comparison of the measured shear stress values for the Day 0 and Day 3 samples of the conventional process and the Liquid P process.

TABLE 4

| | Shear Rate | Conventional | Conventional | Liquid P | Liquid P |
|---|---|---|---|---|---|
| Step | (¹/s) | Day 0 at 12.5° C. | Day 3 at 12.5° C. | Day 0 at 12.5° C. | Day 3 at 12.5° C. |
| 1 | 0 | 0 | 0 | 0 | 0 |
| 2 | 0 | 2.8 | 1.4 | 4.2 | 11.2 |
| 3 | 0.28 | 7 | 1.4 | 19.6 | 57.4 |
| 4 | 0.7 | 9.8 | 4.2 | 26.6 | 79.8 |
| 5 | 1.4 | 11.2 | 5.6 | 35 | 100.8 |
| 6 | 2.8 | 18.2 | 8.4 | 46.2 | 131.6 |
| 7 | 5.6 | 33.6 | 14 | 61.6 | 172.2 |
| 8 | 11.2 | 46.2 | 19.6 | 86.8 | 228.2 |
| 9 | 22.4 | 64.4 | 29.4 | 127.4 | 306.6 |
| 10 | 33.6 | 78.4 | 37.8 | 159.6 | 362.6 |
| 11 | 44.8 | 89.6 | 43.4 | 187.6 | 408.8 |
| 12 | 56 | 99.4 | 49 | 212.8 | 448 |
| 13 | 67.2 | 109.2 | 56 | 235.2 | 481.6 |
| 14 | 0 | 0 | 0 | 0 | 0 |
| 15 | 56 | 98 | 50.4 | 207.2 | 435.4 |
| 16 | 44.8 | 84 | 42 | 177.8 | 385 |
| 17 | 33.6 | 70 | 35 | 147 | 330.4 |
| 18 | 22.4 | 54.6 | 26.6 | 113.4 | 268.8 |
| 19 | 11.2 | 36.4 | 16.8 | 74.2 | 191.8 |
| 20 | 5.6 | 25.2 | 11.2 | 49 | 138.6 |
| 21 | 2.8 | 16.8 | 7 | 35 | 102.2 |
| 22 | 1.4 | 12.6 | 5.6 | 25.2 | 78.4 |
| 23 | 0.7 | 8.4 | 1.4 | 21 | 61.6 |
| 24 | 0.28 | 8.4 | 2.8 | 15.4 | 44.8 |

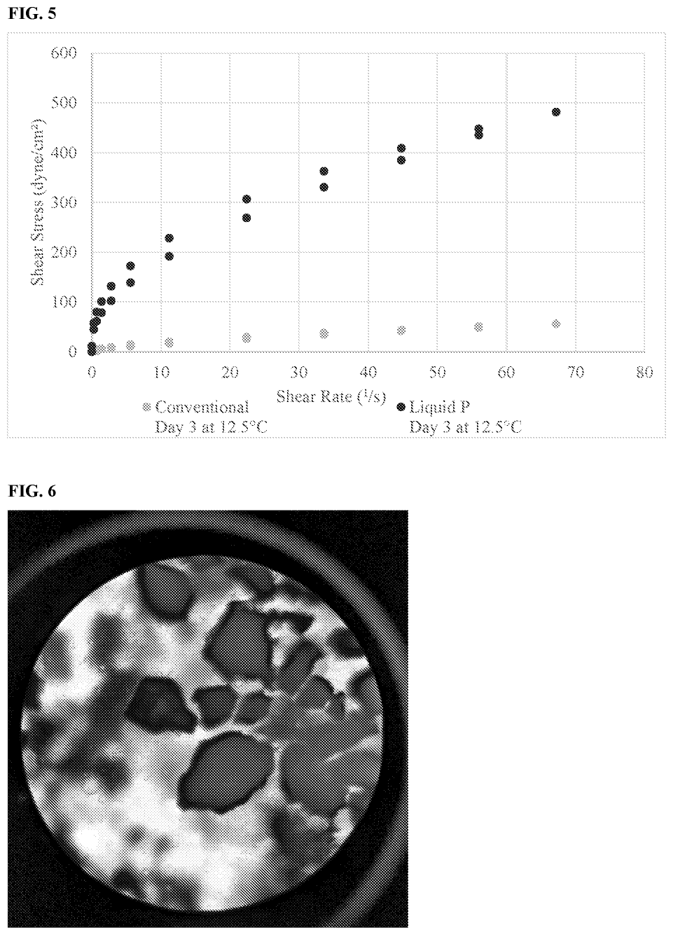

FIG. 4 depicts a graph that compares the shear stress relative to the shear rate for the Day 0 samples, while FIG. 5 depicts a graph that compares the shear stress relative to the shear rate for the Day 3 samples. As shown in FIG. 4, the Liquid P product produced by the inventive method exhibited a higher viscosity and a slightly non-Newtonian rheology relative to the product produced by the conventional method at Day 0. As shown in FIG. 5, the rheological differences between the Liquid P product and the conventional product became much more apparent at Day 3. More particularly, FIG. 5 shows that the Liquid P product was able to achieve a much higher viscosity (as indicated by the higher shear stress) relative to the conventional product, which actually decreased from Day 0 to Day 3. Furthermore, the Liquid P product demonstrated a clear non-Newtonian rheology at lower shear rates (less than 10 μs). Thus, the Liquid P product exhibited and was able to achieve a much more desirable rheological profile over time relative to the conventional product. Although not wishing to be bound by theory, it is believed that this rheological profile of the Liquid P product may be at least partially derived from the high shearing conditions used for its production.

Therefore, FIGS. 4 and 5 demonstrate how the Liquid P product exhibits and retains desirable rheological properties at 12.5° C. that closely reflect the desired rheological profiles of certain food products.

### Example 2—Coarse Grind (Cold Milling)

A potato feed according to the formulation depicted in TABLE 5, below, was subjected to cold milling and coarse grinding. All percentages presented in TABLE 5 correspond to the weight percent of the noted ingredient, based on the total weight of the sample.

TABLE 5

| Ingredient | Weight % |
|---|---|
| IQF Potato Cubes ⅜″ | 50.0 |
| Sunflower Oil | 9.9 |
| Water | 40.0 |
| Sodium Benzoate (preservative) | 0.05 |
| Potassium Sorbate (preservative) | 0.05 |

First, sodium benzoate and potassium sorbate were dispersed in a small quantity of water. Furthermore, the potato ingredients were previously pre-diced, blanched, chelated and frozen prior to creating the potato feed.

Next, frozen potato cubes, the sunflower oil, and water were premixed in a container to a total recipe weight of 12.5 kg and added to the Groen kettle (20 L volume), which contained a heated jacket and a swept wall agitator. The mixture was gently warmed (<10° C.) in the Groen kettle until the potato pieces were completely thawed.

The mixture was then poured into an Urschel Comitrol® (Model 1700) mill fitted with a 190084-1° head (i.e., a relatively coarse grind head with an opening of 389 microns) running at 9,390 rpm. The flow rate into the mill was maintained to ensure the current drawn by the motor was about 25 amps. The 12.5 kg mixture was processed in less than 60 seconds.

The temperature of the product mixture into the mill was 2° C. and the temperature of the mixture exiting the mill was 5° C. Some of this temperature increase was attributed to the mechanical work done on the mixture, but also to heat transfer from the room temperature (˜20° C.) steel of the mill to the mixture. The potato in the mixture was therefore milled before full gelatinization of the native starch (i.e., cold milled).

Immediately following milling the mixture, the fineness of the mixture was measured with a BYK-Gardner 2512 Metal Grind Gauge #PD-250 using the method described in ISO 1524 (2020). It was observed that the fineness size was 225 microns. The resulting milled mixture was in the form of a white free-flowing slurry.

The milled mixture was also examined with microscopy (100× magnification under bright-field mode with unpolarized illumination and stained with Lugol solution (iodine). FIG. 6 is a photograph of this microscopy image.

A portion of the milled mixture was removed and heated indirectly to 84° C. for 3 minutes. As the product warmed, the rheology changed and the milled product thickened as the native potato starch gelatinized and became a thick, flowable, and cohesive mass. This hot cooked product was then poured into containers and allowed to cool in a fridge at 4° C., where it was then stored.

After cooling, the milled product became a firm gel. As discussed above, the texture development of this gel was tracked using a Brookfield CTX Texture Analyzer fitted with a CTX050 load cell and TA2/1000 probe at a constant rate (2 mm/sec). The texture analysis was done directly after the product was removed from the fridge, while the product was at a temperature of 5 to 10° C.

### Example 3—Fine Grind (Cold Milling)

A potato feed mixture according to TABLE 5, above, was prepared in accordance with the procedure described in Example 2.

The mixture was poured into an Urschel Comitrol® (Model 1700) mill fitted with a 218084-0° head (i.e., a fine grind head with an opening of 64 microns) running at 9,390 rpm. The flow rate into the mill was maintained to ensure the current drawn by the motor was below 80 amps and generally maintained at about 60 amps, thereby indicating a significantly higher level of work relative to the coarse grind head of Example 2. The 12.5 kg mixture was processed in less than 60 seconds.

The temperature of the product mixture into the mill was 3° C. and the temperature of the mixture exiting the mill was 13° C. Some of this temperature increase was attributed to the mechanical work done on the mixture, but also to heat transfer from the room temperature (˜20° C.) steel of the mill to the mixture. The potato in the mixture was therefore milled before full gelatinization of the native starch (i.e., cold milled).

Immediately following milling the mixture, the fineness of the mixture was measured with a BYK-Gardner 2512 Metal Grind Gauge #PD-250 using the method described in ISO 1524 (2020). It was observed that the fineness size was 125 microns. The resulting milled mixture was in the form of a heavy, free-flowing white slurry, which was noticeably thicker than the milled mixture from Example 2.

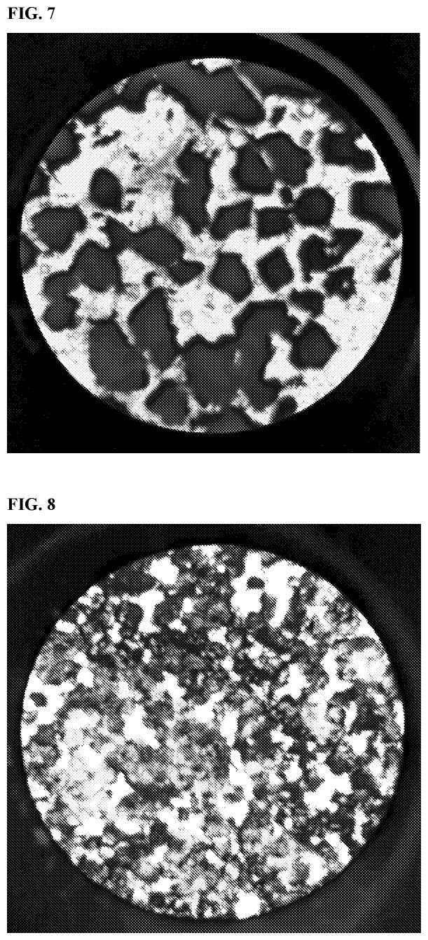

The milled mixture was also examined with microscopy (100× magnification under bright-field mode with unpolarized illumination and stained with Lugol solution (iodine). FIG. 7 is a photograph of this microscopy image.

A first portion of the milled mixture was removed and heated indirectly to 80° C. for 3 minutes (“Sample 3a”) and a second portion of the milled mixture was removed and heated indirectly at 95° C. for 3 minutes (“Sample 3b”). As the products warmed, the rheology changed and the milled products thickened as the native potato starch gelatinized and became thick, flowable, and cohesive masses. These hot cooked products were then poured into containers and allowed to cool in a fridge at 4° C., where they were then stored.

After cooling, the milled products became a firm gel. As discussed above, the texture development of these gels was tracked using a Brookfield CTX Texture Analyzer fitted with a CTX050 load cell and TA2/1000 probe at a constant rate (2 mm/sec). The texture analysis was done directly after the product was removed from the fridge, while the product was at a temperature of 5 to 10° C.

### Example 4—Fine Grind (Hot Milling)

A potato feed mixture according to TABLE 5, above, was prepared in accordance with the procedure described in Example 2, except the mixture was warmed to 85° C. in the Groen kettle prior to milling until the potato pieces were completely cooked through.

The mixture was then poured into an Urschel Comitrol® (Model 1700) mill fitted with a 218084-0° head (i.e., a fine grind head with an opening of 64 microns) running at 9,390 rpm. The flow rate into the mill was maintained to ensure the current drawn by the motor was below 80 amps and generally maintained at about 50 amps, thereby indicating a significantly higher level of work relative to the coarse grind head of Example 2. The 12.5 kg mixture was processed in less than 60 seconds.

The temperature of the product mixture into the mill was about 85° C. and the temperature of the mixture exiting the mill was about the same. The potato in the mixture was therefore milled with full gelatinization of the native starch (i.e., hot milled).

Immediately following milling the mixture, the fineness of the mixture was measured with a BYK-Gardner 2512 Metal Grind Gauge #PD-250 using the method described in ISO 1524 (2020). It was observed that the fineness size was 15 microns. The resulting milled mixture was in the form of a smooth, free-flowing white liquid.

The milled mixture was also examined with microscopy (100× magnification under bright-field mode with unpolarized illumination and stained with Lugol solution (iodine). FIG. 8 is a photograph of this microscopy image.

A portion of the milled mixture was removed and heated indirectly to 80° C. for 3 minutes and then further to 95° C. As the product warmed, the rheology changed and the milled product thickened as the native potato starch gelatinized and became a thick, flowable, and cohesive mass, but was less viscous relative to the cold mill products of Examples 2 and 3. This hot cooked product was then poured into containers and allowed to cool in a fridge at 4° C., where it was then stored.

After cooling, the milled product became a firm gel. As discussed above, the texture development of this gel was tracked using a Brookfield CTX Texture Analyzer fitted with a CTX050 load cell and TA2/1000 probe at a constant rate (2 mm/sec). The texture analysis was done directly after the product was removed from the fridge, while the product was at a temperature of 5 to 10° C.

As shown in FIGS. 6-8, the microscope imaging of Examples 2-4 demonstrated the impact that the different milling conditions had on the resulting starch granules from the potatoes. More particularly, the cold milling with a coarse grind of Example 2 yielded generally larger and fewer starch particles relative to the cold milling with a fine grind in Example 3. Furthermore, there did not appear to be any intact native starch granules in the coarse grind sample of Example 2.

There was a notable different between the fine ground samples derived from cold milling (Example 3) and those derived from hot milling (Example 4). The hot milling sample had significantly smaller particle sizes and did not contain any dense starch granules.

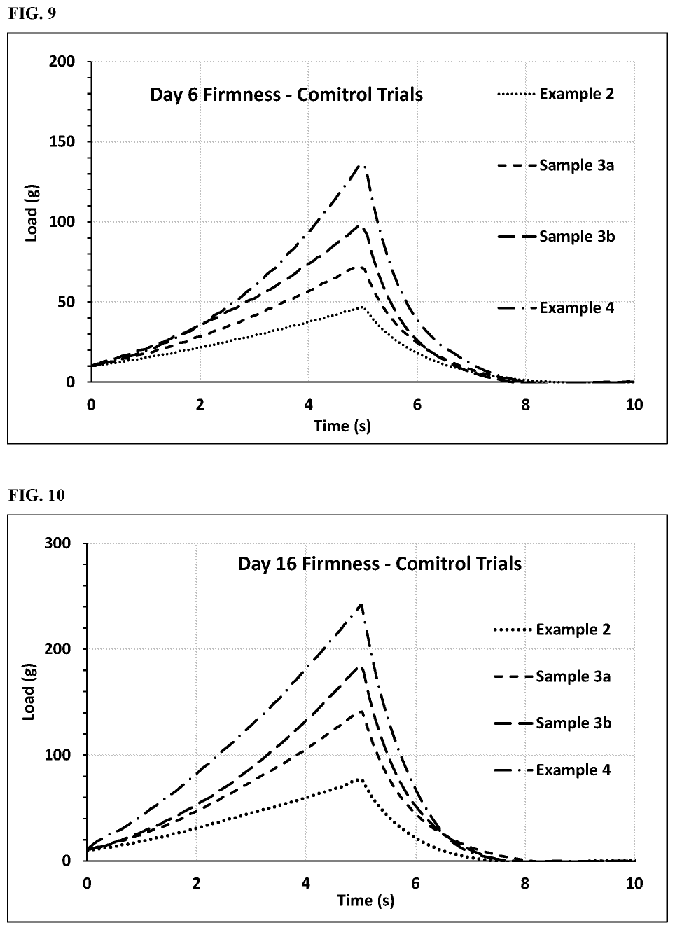

The texture measurements for Examples 2-4 were carried out at Day 6 and Day 16 (the day of production being Day 0) and are depicted in FIGS. 9 and 10, respectively. The graphs in FIGS. 9 and 10 demonstrate the load registered as a probe was pushed into the product (i.e., compressive stress) at a constant rate until it traveled a predetermined distance of 10 mm, after which the probe was withdrawn.

As shown in FIG. 9, the texture measurements at Day 6 demonstrated that the coarse cold mill product (Example 2) showed the lowest level of firmness, achieving a maximum load of 54 g. This was closely followed by Sample 3a of Example 3 (i.e., the first portion of the fine cold mill product heated to 80° C.), which achieved a maximum load of 62 g. Both Sample 3b of Example 3 (i.e., the second portion of the fine cold mill product heated to 95° C.) and the fine hot mill product of Example 4 exhibited significantly superior firmness values with maximum loads of 88 g and 102 g, respectively.

As shown in FIG. 10, the texture measurements at Day 16 demonstrated that all products had become firmer but had also started to diverge regarding texture characteristics more noticeably. The coarse cold mill product (Example 2) still showed the lowest level of firmness with an increased load of 78 g. Sample 3a of Example 3 (i.e., the first portion of the fine cold mill product heated to 80° C.) was also markedly firmer, with a maximum load of 140 g. Meanwhile, Sample 3b of Example 3 (i.e., the second portion of the fine cold mill product heated to 95° C.) exhibited a maximum load of 190 g. Lastly, the fine hot mill product of Example 4 exhibited the best texture characteristics with a maximum load of 240 g.

Accordingly, it was shown that the combination of hot milling with fine milling led to the formation of products with superior texture characteristics.

### Example 5 and Comparative Example 1—Hot Inventive Shearing vs. Conventional Shearing

A potato feed according to the formulation depicted in TABLE 6, below, was formed for these test samples. All percentages presented in TABLE 6 correspond to the weight percent of the noted ingredient, based on the total weight of the sample.

TABLE 6

| Ingredient | Weight % |
|---|---|
| IQF Potato Cubes ⅜″ | 50.00% |
| Sunflower Oil | 9.94% |
| Water | 40.00% |
| Sodium Benzoate (preservative) | 0.03% |
| Potassium Sorbate (preservative) | 0.03% |

The sodium benzoate and potassium sorbate were added to a portion of water and allowed to hydrate and disperse for at least 5 minutes. Both of these ingredients functioned as preservatives and had no function relating to the textural properties of the final product. The purpose of these additives was to function as preservatives to limit the growth of mold and other spoilage microorganisms in the products, so that the texture development could be monitored over several weeks.

The oil and water were initially blended and gently heated in a microwave oven (1,200 W, 110 v Panasonic Rotary Model NSD997S) to 85° C. Subsequently, the frozen IQF diced potatoes were added to the oil/water blend to form a reaction mixture, which was then heated again to 85° C. in the microwave.

The reaction mixture was then put hot into a Robot Coup Blixer 2 (2.9 L capacity) industrial food blender. The batch size was 1,400 g. The blender was then run at a low-speed setting until the product had been pureed into the form of a smooth homogeneous mass with no remaining pieces of diced potatoes.

At this point, the mass was split in half into the batches for Example 5 and Comparative Example 1, so that the hot milling process could be compared to the “conventional” process.

For Comparative Example 1, half of the pureed mass was deposited into silicon molds, sealed, and placed in the refrigerator to demonstrate the conventional process.

For Example 5, the other half of the pureed mass was further milled in the Robot Coupe on high speed for at least 10 minutes. During this time, the mixture obtained a glossy appearance. Afterwards, the mixture was deposited into silicon molds, sealed, and placed in the refrigerator.

Both Comparative Example 1 and Example 5 were allowed to cool over at least 24 hours to ensure that the mold had cooled all the way through. For texture testing, the formed blocks were removed from the refrigerator and allowed to warm at room temperature to about 15° C. prior to unsealing. This was done to minimize any condensation on the product surface, which could interfere with the results.

The product texture was measured using a Brookfield CTX Texture Analyzer fitted with a CTX050 load cell and TA2/1000 probe at a constant rate (2 mm/sec). The results were digitally captured using the accompanying Texture Pro 1.0.14 software with the load registered as a probe was pushed into the product (i.e., compressive stress) at a constant rate (2 mm/sec) until it traveled a predetermined distance of 10 mm, after which the probe was withdrawn at a constant rate (2 mm/sec).

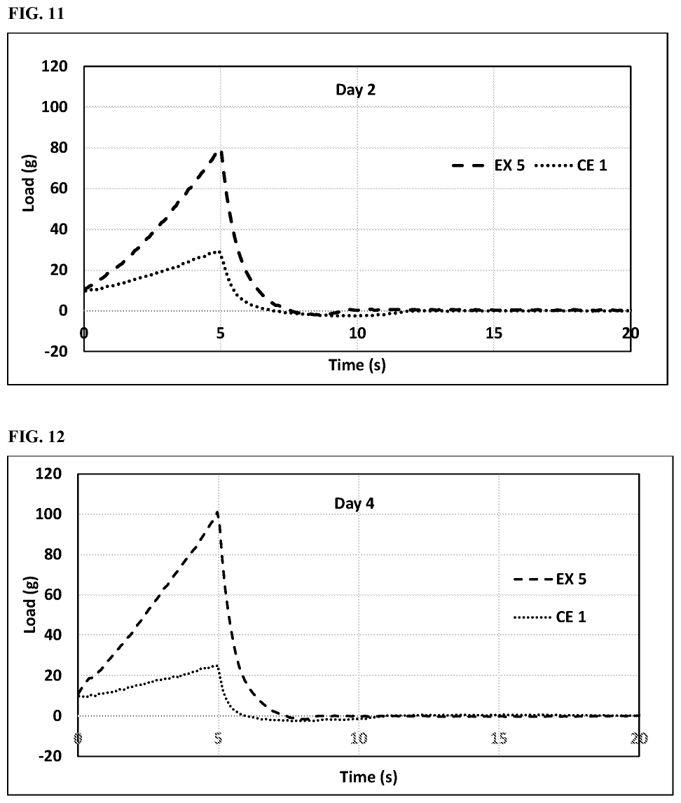

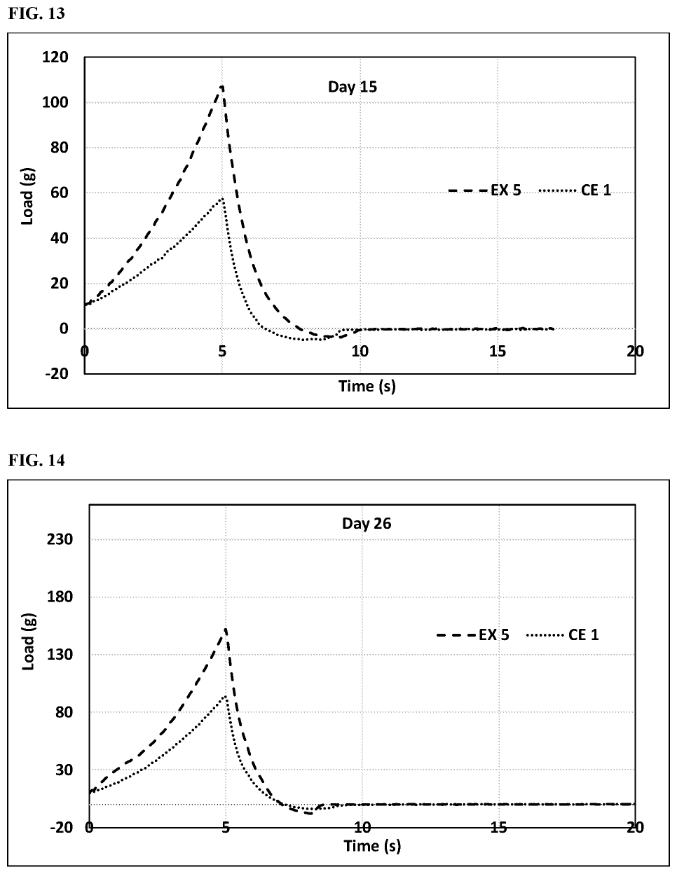

As shown in FIGS. 11-15, texture measurements were carried out over several days (i.e., Days 2, 4, 15, 26, and 70). The texture measurements demonstrated that Example 5 always exhibited higher firmness relative to Comparative Example 1; however, for both Example 5 and Comparative Example 1, the firmness increased for both products as they aged.

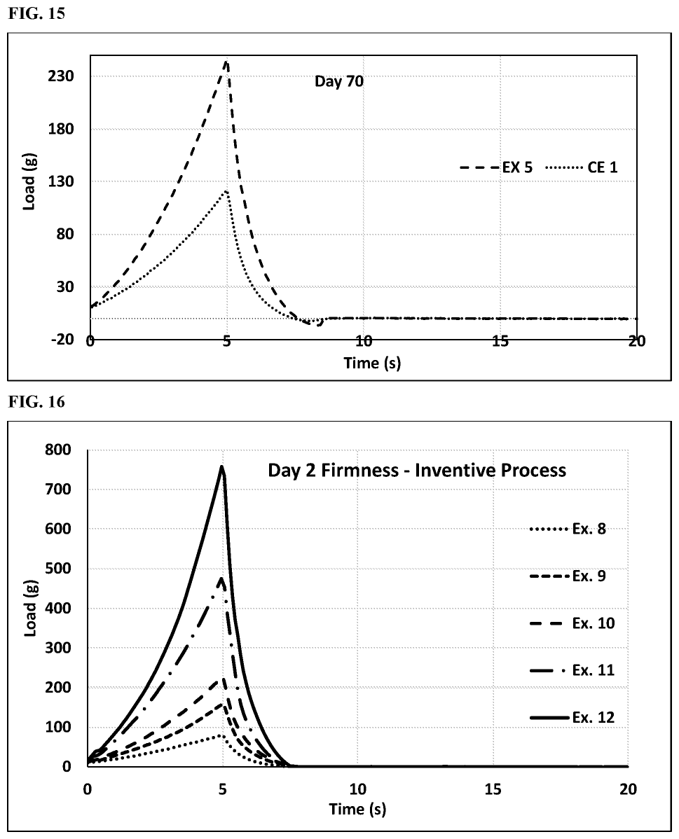

As demonstrated by FIGS. 11-15, the products start to increase in firmness as they age. At Day 1, the firmness of Comparative Example 1 was not measurable due its lack of firmness. As shown in FIGS. 11-15, the product produced in accordance with Example 5 exhibited noticeably superior firmness relative to the product produced according to Comparative Example 1. As shown by FIG. 11, even by Day 2, the two processes show a notably distinct difference in firmness. Although both products increased in firmness over time, the product produced in accordance with Example 5 did so at a faster rate and remained firmer over an extended period of 70 days, as shown in FIG. 15. Although not wishing to be bound by theory, it is believed that the product produced in accordance with Example 5 had a different and superior microstructure relative to the product produced in accordance with Comparative Example 1, which contributed to the sample's superior texture formation and retention over time.

### Examples 6-12 and Comparative Examples 2-8—Variability of Recipe and Texture Firmness

To observe the effects that recipe variability had on the texture characteristics of the resulting molds, various molded samples were prepared based on the formulations in TABLES 7 and 8, below, and in accordance with the milling and molding procedures used for Example 5 and Comparative Example 1. All percentages presented in TABLES 7 and 8 correspond to the weight percent of the noted ingredient, based on the total weight of the sample. Examples 6-12 were produced in accordance with the process used to produce Example 5, while Comparative Examples 2-8 were produced in accordance with the process used to produce Comparative Example 1.

TABLE 7

| Ingredient | Ex. 6 | Ex. 7 | Ex. 8 | Ex. 9 | Ex. 10 | Ex. 11 | Ex. 12 |
|---|---|---|---|---|---|---|---|
| IQF diced Potato | 30.00% | 40.00% | 50.00% | 60.00% | 70.00% | 80.00% | 89.00% |
| Sunflower Oil | 9.94% | 9.94% | 9.94% | 9.94% | 9.94% | 9.94% | 9.94% |
| Water | 60.00% | 50.00% | 40.00% | 30.00% | 20.00% | 10.00% | 1.00% |
| Sodium Benzoate | 0.03% | 0.03% | 0.03% | 0.03% | 0.03% | 0.03% | 0.03% |
| Potassium | 0.03% | 0.03% | 0.03% | 0.03% | 0.03% | 0.03% | 0.03% |
| Sorbate | | | | | | | |

TABLE 8

| | Comp. | Comp. | Comp. | Comp. | Comp. | Comp. | Comp. |
|---|---|---|---|---|---|---|---|
| Ingredient | Ex. 2 | Ex. 3 | Ex. 4 | Ex. 5 | Ex. 6 | Ex. 7 | Ex. 8 |
| IQF diced Potato | 30.00% | 40.00% | 50.00% | 60.00% | 70.00% | 80.00% | 89.00% |
| Sunflower Oil | 9.94% | 9.94% | 9.94% | 9.94% | 9.94% | 9.94% | 9.94% |
| Water | 60.00% | 50.00% | 40.00% | 30.00% | 20.00% | 10.00% | 1.00% |
| Sodium Benzoate | 0.03% | 0.03% | 0.03% | 0.03% | 0.03% | 0.03% | 0.03% |
| Potassium | 0.03% | 0.03% | 0.03% | 0.03% | 0.03% | 0.03% | 0.03% |
| Sorbate | | | | | | | |

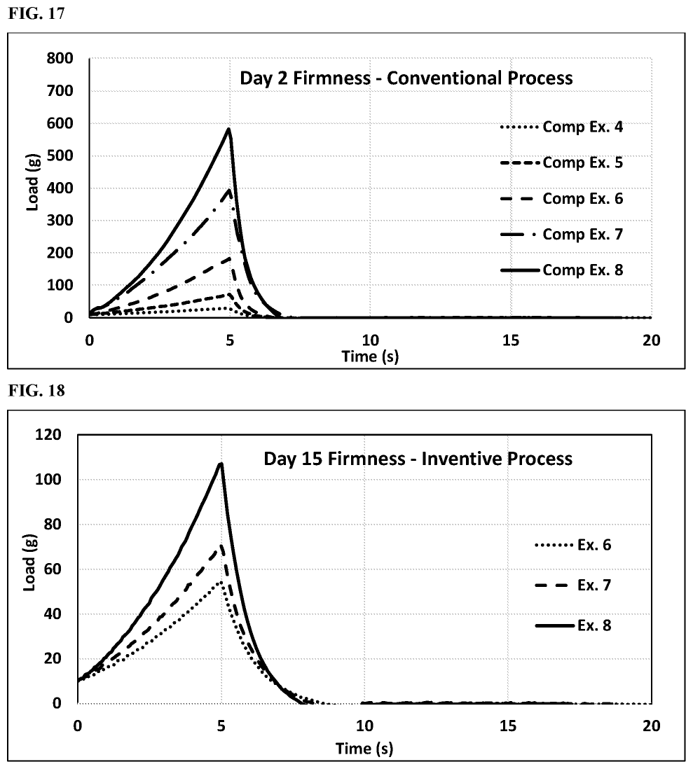

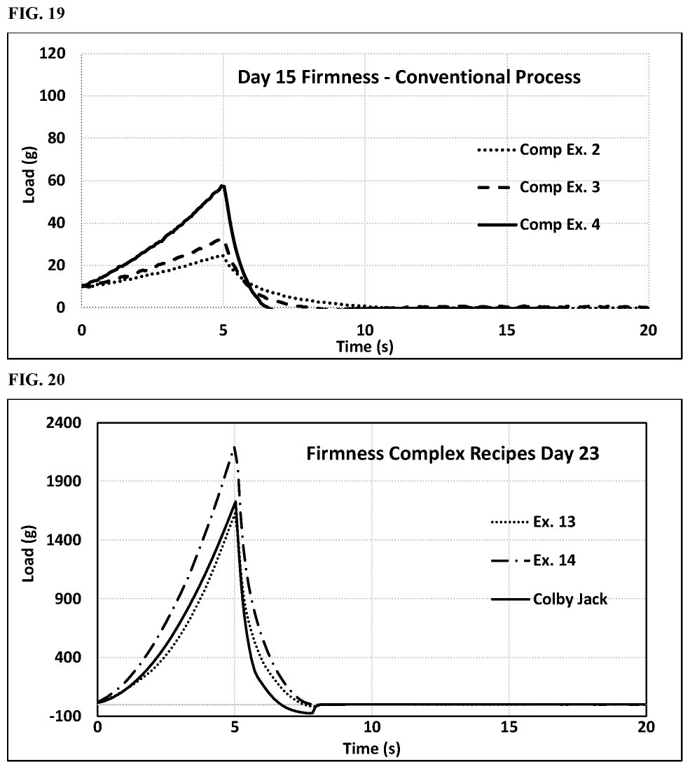

As shown in FIGS. 16-19, for the same level of potato ingredient, the molded products of Examples 6-12 made with the inventive process used for Example 5 exhibited higher levels of firmness than Comparative Examples 2-8, which were made with the conventional process used for Comparative Example 1. Although, the difference in firmness between the two processes becomes less notable with higher levels of potato ingredient, it is still evident at these higher levels. In general, higher levels of potato showed higher levels of firmness. The firmness was measured using the same procedure described above for Example 5.

Furthermore, as shown in FIGS. 16-19, Examples 6-8 and Comparative Examples 2-4, which contained lower levels of potatoes, were less firm, slower to form, and were more easily measured at day 15. Nevertheless, they still exhibited the benefits of the inventive hot milling process described herein (i.e., superior texture).

### Examples 13 and 14—Complex Recipes with Improved Cheese Characteristics

As noted above, ingredients aside from potato, oil, and water can be added to improve the flavor, color, mouthfeel, melt properties, cost, and shelf life of the product. To demonstrate the influence of additional additives and their effects on the cheese-like characteristics of the resulting product, two separate potato feed (1 kg each) was prepared in accordance with the formulations listed in TABLE 9, below. All percentages presented in TABLE 9 correspond to the weight percent of the noted ingredient, based on the total weight of the sample.

TABLE 9

| Ingredient | Example 13 | Example 14 |
|---|---|---|
| IQF diced Potato | 15.23 | 20.80 |
| IQF Sweet Potato | 3.00 | 0.00 |
| Sunflower Oil | 2.09 | 2.72 |
| Water | 39.36 | 35.26 |
| Salt | 1.20 | 1.36 |
| Coconut Oil (Refined, | 17.32 | 16.28 |
| Bleached and Deodorized) | | |
| Lactic Acid (88%) | 0.34 | 0.33 |
| Guar Gum | 0.00 | 0.18 |
| Sodium Benzoate | 0.03 | 0.03 |
| Emulismart/Nutrava | 0.55 | 0.45 |
| Ticagel KX | 1.35 | 1.81 |
| Prime Lyte 371 L/Yeast extract | 0.50 | 0.00 |
| Flavours/Minerals/Vitamins | 0.90 | 0.90 |
| Native Tapioca Starch | 18.13 | 20.79 |

The sodium benzoate was added to a portion of water and allowed to hydrate and disperse for at least 5 minutes. In addition, the frozen potatoes and coconut were gently heated in a microwave to thaw and melt, respectively, and to raise their temperatures to 85° C. Subsequently, the potato and water phase were added to a Robot Coupe Blixer 4 (4.5 L capacity 1.5 HP/1.12 KW motor) and blended for two minutes at max speed (3,500 RPM). Afterwards, the oil Emulismart/Nutrava and lactic acid were added to the Blixer and blended for one minute at max speed. The resulting temperature of the mixture was 40° C.

At this point, the remaining ingredients, except for the native/modified starch, were added to the Blixer and blended in for 6 to 10 minutes at max speed. The resulting temperature of the mixture was 60° C. Subsequently, the native/modified starch was added slowly to the Blixer, while blending. The temperature of the mixtures raised to about 75 to 80° C. and they started to thicken until the motor of the Blixer started to overload and trip out. At this stage, the mixtures were cohesive and viscous masses, which were then poured into containers, sealed, and placed in a refrigerator for cooling and storage. Once cooled, the mixtures were firm enough to be removed from the containers.

The textures of the molded mixtures were measured in accordance with the procedure described above in Example 5. For comparison purposes, the samples of Examples 13 and 14 were compared to a store purchased Colby Jack (Kroeger). FIG. 20 depicts the texture measurements of all three samples at Day 23. As shown in FIG. 20, Examples 13 and 14 had very similar texture characteristics to a conventional Colby Jack cheese.

### Example 15—Complex Recipe with Improved Cheese Characteristics

As noted above, ingredients aside from potato, oil, and water can be added to improve the flavor, color, mouthfeel, melt properties, cost, and shelf life of the product. To demonstrate the influence of additional additives and their effects on the cheese-like characteristics of the resulting product, three separate potato feeds (75 kg) were prepared in accordance with the formulation listed in TABLE 10, below. All percentages presented in TABLE 10 correspond to the weight percent of the noted ingredient, based on the total weight of the sample. These samples were labeled Samples 15a, 15b, and 15c, and all three contained the same formulation.

TABLE 10

| Ingredient | Example 15 |
|---|---|
| IQF diced Potato | 30.00 |
| IQF Sweet Potato | 1.50 |
| Carrot Puree | 2.00 |
| Water | 24.68 |
| Salt | 1.20 |
| Coconut Oil RBD | 19.50 |
| Lactic Acid (60% | 0.60 |
| Nutrava Peak | 0.50 |
| Savor-Lyfe CA | 0.50 |
| Flavours/ | 1.52 |
| Modified potato starch | 18.00 |

Initially, the coconut oil was melted at 45° C. in preparation for the experiment. Subsequently, the water was added to a Stephan Universal Batch Cooker UM200, which utilized direct steam injection for product heating. The water was heated to 80° C. Afterwards, the frozen root vegetables (i.e., potatoes and sweet potatoes) and the carrot puree were added to the Cooker and stirred for about five minutes to thaw the frozen vegetables. Direct steam injection was used as required to raise the temperature of the mixture to 40° C.

At this stage, the speed of the agitator blade was increased to 50% for Sample 15a, 75% for Sample 15b, and 100% for Sample 15c, and the Cooker maintained these speeds for six minutes. At this stage, a sample was taken from Samples 15a, 15b, and 15c to measure fineness (“Fineness Measurement A”). Fineness was measured as described in Examples 2-4.

Next, the powder ingredients and lactic acid were added to the mixtures in the Cooker and the agitator was ran at 100% speed for two minutes in order to thoroughly mix in all of the ingredients. A sample was taken from each of the mixtures once again to measure fineness (“Fineness Measurement B”).

Next, the melted coconut oil was added to the mixture and the agitator was ran at 100% speed for two minutes for final milling and emulsification of the oil phase. Direct steam injection was used to raise the temperature of the mixture to 85° C. The mixture was held at this temperature in the Cooker and another sample was taken from each of the mixtures once again to measure fineness (“Fineness Measurement C”).

At this stage, all three samples were poured into molds and refrigerated. Depending on the dimensions of the molds, the products could be removed from the molds and sliced and/or grated within 1 to 20 days.

The samples taken for Fineness Measurements A, B, and C were tested for fineness using the grind gauge technique described in Example 2, so that the level of particle size reduction during the process could be analyzed. The results of these analyses are provided in TABLE 11, below.

TABLE 11

| Production Stage sample | Fineness | |
|---|---|---|
| A - initial cold milling of root vegetables at 100%, | 150-200 | μm |
| 75% or 50% blade speed | | |
| B - following addition and mixing of powder ingredients | 50-100 | μm |
| C - following oil addition and final milling stage at 85° C. | <10 | μm |

As shown in TABLE 11, the most significant particle size reduction happened during hot milling in the presence of oil (Stage C, i.e., Fineness Measurement C); although the total shear experienced was presumed to be accumulative over all three milling phases, which is supported by the different hardness measurements of the final product.

Additionally, Samples 15a, 15b, and 15c were tested for sample firmness 41 days after production using a texture analyzer (TA.XT-Plus from Stable Micro Systems) in compression mode fitted with a metal knife type probe (Extended Craft knife A/ECB). During this test, the knife would cut through the product at a speed of 2 mm/s and the force required during the travel of the knife through the product was digitally captured by the unit. The samples were analyzed directly after removal from the fridge (at about 4° C.) and three repeat measures were done on each sample. The results of these tests are provided in TABLE 12, below.

TABLE 12

| | Mean Max |
|---|---|
| Sample | Cutting Force (N) |
| Sample 15c (100%) | 43.13 ± 5.01 |
| Sample 15b (75%) | 40.44 ± 5.11 |
| Sample 15a (50%) | 28.75 ± 1.46 |

The penetration through all samples proceeded smoothly with no fracturing of the products, thereby leaving a smooth cut surface. This indicated that the products were ideal for slicing and grating in the same manner as many cheeses.

As shown in TABLE 12, the results of the texture measurements for Samples 15a, 15b, and 15c show that the higher levels of shear used during the cold milling of the potatoes (as represented by the 100% and 75% agitator speeds) produced a firmer product.

Additionally, the microstructures of Samples 15a, 15b, and 15c were analyzed after formation of their respective products. A 1 cm³ cube of each product sample was frozen in liquid nitrogen and 10 μm thick slices were cut out with a microtome. The samples were then stained with an iodine solution and then viewed at different magnifications under green light through a compound light microscope in Brightfield mode. The analysis showed that there were limited visual differences between the three samples. All had fine and uniform fat droplet distributions throughout a continuous starch gel network, although with some still intact starch domains. This analysis confirmed the low fineness (<10 μm) measurements found at the end of milling.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the term “potato component” refers to the component in the potato feed that is derived solely from potatoes.

As used herein, the term “dairy analogue” refers to a food product that can be used in the same capacity as the noted dairy food product, but does not contain any ingredients that are derived from milk.

As used herein, a “modified starch” refers to a starch derivative that has been produced by physically, enzymatically, or chemically altering an initial starch.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### CLAIMS NOT LIMITED TO DISCLOSED EMBODIMENTS

he preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

he inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A method for producing a dairy analogue, said method comprising:
(a) providing an initial potato feed comprising a plurality of potatoes;
(b) at least partially gelatinizing at least a portion of said initial potato feed to thereby form a gelatinized potato feed;
(c) shearing at least a portion of said gelatinized potato feed at a temperature of at least 50° C. to thereby form a liquid potato product,
wherein said shearing provides at least 20 kJ/kg of mechanical work as measured over a time period of 15 minutes or less,
wherein said shearing occurs in the presence of one or more of the following—
(i) at least one oil exhibiting a melting point in a range of 23° C. to 45° C., or
(ii) at least one native starch and/or a modified starch;
(d) introducing at least a portion of said liquid potato product in a shaped mold; and
(e) solidifying said liquid potato product in said shaped mold to thereby form said dairy analogue.

2. The method according to claim 1, wherein said partially gelatinizing comprises blanching, and wherein said shearing occurs over a time period of at least 2 minutes and at a temperature of at least 55° C.

3. The method according to claim 1, wherein said shearing comprises a plurality of shearing stages, wherein each of said shearing stages comprises different shearing times and conditions.

4. The method according to claim 1, wherein said shearing occurs in the presence of said oil, wherein said oil comprises coconut oil, hydrogenated palm oil, cocoa butter, shea butter, or a combination thereof.

5. The method according to claim 1, wherein said shearing occurs in the presence of said native starch and/or said modified starch.

6. The method according to claim 1, wherein said solidifying comprises maintaining said liquid potato product in said shaped mold at 1° C. to 20° C. for at least five days.

7. The method according to claim 1, further comprising, prior to said shearing, preheating said initial potato feed and/or said gelatinized potato feed to a temperature of at least 65° C.

8. The method according to claim 1, wherein said dairy analogue exhibits a maximum load of at least 100 grams as measured at 15 days after said solidifying as measured with a Brookfield CTX Texture Analyzer fitted with probe TA2/1000.

9. The method according to claim 1, wherein said liquid potato product has a particle fineness of less than 125 microns as measured with a BYK-Gardner 2512 Metal Grind Gauge (PD-250) in accordance with ISO 1524 (2020).

10. A dairy analogue produced by said method according to claim 1.

11. A method for producing a dairy analogue, the method comprising:
(a) providing an initial potato feed comprising a plurality of potatoes;
(b) at least partially gelatinizing at least a portion of said initial potato feed to thereby form a gelatinized potato feed;
(c) shearing at least a portion of said gelatinized potato feed at a temperature of at least 25° C. to thereby form a liquid potato product,
wherein said shearing provides at least 100 kJ/kg of mechanical work as measured over a time period of 30 minutes or less,
wherein the shearing occurs in the presence of one or more of the following—
(i) at least one oil, or
(ii) at least one native starch and/or a modified starch, and
wherein said liquid potato product has a particle fineness of less than 125 microns as measured with a BYK-Gardner 2512 Metal Grind Gauge (PD-250) in accordance with ISO 1524 (2020);
(d) introducing at least a portion of the liquid potato product in a shaped mold; and
(e) solidifying said liquid potato product in said shaped mold to thereby form said dairy analogue,
wherein said dairy analogue exhibits a maximum load of at least 100 grams as measured at 15 days after said solidifying as measured with a Brookfield CTX Texture Analyzer fitted with probe TA2/1000.

12. The method according to claim 11, wherein said partially gelatinizing comprises blanching, and wherein said shearing occurs over a time period of at least 2 minutes and at a temperature of at least 55° C.

13. The method according to claim 11, wherein said shearing comprises a plurality of shearing stages, wherein each of said shearing stages comprises different shearing times and conditions.

14. The method according to claim 11, wherein said shearing occurs in the presence of said oil, wherein said oil comprises coconut oil, hydrogenated palm oil, cocoa butter, shea butter, or a combination thereof.

15. The method according to claim 11, wherein said shearing occurs in the presence of said native starch and/or said modified starch.

16. The method according to claim 11, wherein said solidifying comprises maintaining said liquid potato product in said shaped mold at 1° C. to 20° C. for at least one day.

17. The method according to claim 10, further comprising, prior to said shearing, preheating said initial potato feed and/or said gelatinized potato feed to a temperature of at least 65° C.

18. A dairy analogue produced by said method according to claim 11.

19. A dairy analogue formed from a liquid potato product, wherein said dairy analogue exhibits a maximum load of at least 100 grams as measured at 15 days after said solidifying as measured with a Brookfield CTX Texture Analyzer fitted with probe TA2/1000,
wherein said liquid potato product:
(a) comprises potatoes and water,
(b) comprises one or more of the following—
(i) at least one oil exhibiting a melting point in the range of 23° C. to 45° C., or
(ii) at least one native starch and/or a modified starch, wherein said native starch and modified starch comprise an amylose content of less than 19 weight percent, based on the total weight of the starch, and
(c) has a particle fineness of less than 125 microns as measured with a BYK-Gardner 2512 Metal Grind Gauge (PD-250) in accordance with ISO 1524 (2020).

20. The dairy analogue according to claim 19, wherein said liquid potato product comprises said oil, wherein said oil comprises coconut oil, hydrogenated palm oil, cocoa butter, shea butter, or a combination thereof
